(19) United States
(12) Patent Application Publication
(10) Pub. No.: US 2018/0259252 A1
(43) Pub. Date: Sep. 13, 2018

(54) Dust Reduction Apparatus Depending on Supply of Falling Coal in Coal Drying Apparatus Using Reheat Steam

(71) Applicant: HANKOOK TECHNOLOGY INC., Seoul (KR)

(72) Inventor: Sung Kon KIM, Anyang-si Gyeonggi-do (KR)

(21) Appl. No.: 15/541,232

(22) PCT Filed: Jun. 17, 2015
(86) PCT No.: PCT/KR2015/006148

§ 371 Date: Jun. 30, 2017

(30) Foreign Application Priority Data
Jan. 2, 2015 (KR) 10-2015-0000077
Jan. 2, 2015 (KR) 10-2015-0000079
Jan. 2, 2015 (KR) 10-2015-0000081
Jan. 2, 2015 (KR) 10-2015-0000083
Jan. 2, 2015 (KR) 10-2015-0000089

(51) Int. Cl. F26B 3/06; F26B 25/00; F26B 15/18; C10B 57/10

(52) U.S. Cl. CPC F26B 3/06; F26B 25/008; F26B 2200/08; C10B 57/10; F26B 15/18

(57) ABSTRACT

A dust reduction apparatus which minimizes dust generation when coal is dropped and supplied from an upper dryer to a lower dryer in a multi-stage dryer for drying coal using reheat steam is provided.

### TECHNICAL FIELD

The present invention relates to an apparatus for reducing dust according to supply of dropping coal in a coal dryer using reheat steam and, more particularly, to an apparatus for reducing dust, which minimizes generation of dust when coal drops and is supplied from an upper dryer to a lower dryer in a multiple stage dryer for drying coal using reheat steam.

### BACKGROUND ART

In general, in a thermal power plant that generates power by using coal as fuel, approximately 180 ton/hr of coal is combusted per 500 MW, and each pulverizer supplies approximately 37 ton of coal to a boiler. In a 500 MW thermal power plant that uses coal, approximately six coal storage silos each having a capacity of approximately 500 ton are installed. Five of them are for normally supplying coal and the other one is operated as a coal storage silo that preliminarily stores coal that may be used for a predetermined period of time.

In addition, in the thermal power plant that generates power by using coal as fuel, the standard thermal power design criterion for coal is designed to use a low moisture bituminous coal of 6,080 Kcal/Kg and 10% or less. In some thermal power plants, imported coal is used. Among the imported coal, some sub-bituminous coal has an average water content of 17% or more, so that combustion efficiency of the boiler is reduced. When a caloric value of the coal having the standard thermal power combustion limit of 5,400 Kcal/Kg is low, a decrease in electric power generation and an increase in fuel consumption are predicted due to a reduction in the combustion efficiency. In addition, when sub-bituminous coal which is high-moisture low caloric coal is used, a water content thereof is higher than a design criterion, so that a transfer system that carries the coal may not be smoothly operated, efficiency when the coal is pulverized by the pulverizer may deteriorate, combustion efficiency may deteriorate due to partial incomplete combustion, and windage of heat distribution generated in the boiler and an abnormal operation may occur. However, in the thermal power plant, to reduce fuel costs, a usage ratio of sub-bituminous coal has gradually increased to approximately 41-60%.

Further, because the global economic recovery is expected and safety issues of a nuclear power plant are faced due to destruction of the nuclear power plant resulting from a Japanese huge earthquake, preference of the thermal power plant becomes higher, and thus, it is predicted that demands and prices of the coal continuously increase. An environment of the world coal market is changed from a customer-centered environment to a supplier-centered environment, and thus, stable supply and demand of coal is different. Further, it is predicted that a production volume of high caloric coal is maintained at a current level, and thus, unbalance of the supply and demand of the coal is predicted.

Although a ratio of low caloric coal among the total reverses of the world's coal is approximately 47%, the low caloric coal has a low caloric value and a high water content, and thus, the high-moisture low caloric coal has difficulty in complete combustion, for example, a combustion failure during combustion. Accordingly, the low caloric coal is ignored in the market. Globally, until recent years, there has been a high tendency to rely on stable petroleum prices and low production unit prices of the nuclear power plant. However, in recent years, a lot of constructions of thermal power plants that use coal are planed due to a sharp rise in petroleum prices and a sense of insecurity to the nuclear power generation.

As the conventional technology of drying coal (thermal drying), a rotary drying scheme of drying internal coal particles using high temperature gas while a cylindrical shell into which coal is input is rotated, a flash drying scheme of drying coal by raising high-temperature drying gas from below to top while coal is supplied from top to below, and a fluid-bed drying scheme of drying coal by upwards raising high-temperature drying gas with fine particles are mainly used.

Moisture of the coal is classified into surface moisture that is attached to pores between coal particles and bound moisture that is coupled to pores inside the coal. Most of the surface moisture is moisture that is sprayed during a washing process in a producing area, transportation and storing, and an amount of the surface moisture is determined based on a surface area and absorptivity. Further, as particles becomes smaller, the surface area becomes larger and capillary tubes between the particles are formed, so that moisture is contained in the coal, and thus, a water content increases. The bound moisture is formed at a creation time of the coal, and bound moistures of brown coal, soft coal (bituminous coal and sub-bituminous coal) and anthracite coal are smaller in the sequence of the brown coal, the soft coal (bituminous coal and sub-bituminous coal) and the anthracite coal. When a large amount of moisture is included in the coal, a caloric value is reduced, and transportation costs are increased, so that it is required to control moisture during processes of mixing, pulverizing and separating the coal.

In addition, a problem occurs in that moisture included in the coal cannot be effectively dried even by spraying reheat steam in a state in which input coal is not uniformly dispersed, in an apparatus for drying coal by spraying high-temperature reheat steam below a dryer while pulverized coal is transferred through a multi-stage dryer, that is, a conveyor having a plurality of through-holes formed therein through which reheat steam passes or a plurality of transfer plates that are coupled to each other. Accordingly, a problem occurs in that stages or lengths of the dryer for drying coal should increase, a supply amount of the reheat steam for drying increases, and thus, costs and times consumed for drying of coal increase.

Korean Patent No. 10-0960793 as the prior art related to the present invention discloses that a low-grade coal stabilizer includes a wave-type vibration flow plate for uniform mixing with heavy oil ash powders that are input into a primarily dried low-grade coal to improve drying efficiency. The vibration flow plate, which uniformly mixes the low-grade coal and the heavy oil ash powders with each other, has an inherent problem in that because drying steam for drying coal is not uniformly sprayed onto the surface of the coal, drying efficiency may deteriorate.

### DISCLOSURE

### Technical Problem

The present invention is conceived to solve the above-described problems, and an aspect of the present invention is to improve drying efficiency of coal by suppressing, shielding and reducing dust from piles of coal which are dried by an upper dryer and drop to a lower dryer and by smoothly operating a plurality of transfer plates by loading the piles of coal on the plurality of transfer plates and dropping the piles of coal through rotation of the transfer plates, in a coal dryer for drying coal used as fuel of a thermal power plant using reheat steam while the coal is transferred to a multi-stage dryer, and to improve a drying function of the coal dryer by minimizing generation of dust while coal is transferred, as the coal dryer is miniaturized, and by dispersing and supplying piles of coal at a specific ratio.

Further, another aspect of the present invention is to reduce fuel consumption by improving combustion efficiency of a boiler of a thermal power plant by maintaining a proper water content due to effective drying of the coal and thus increasing a caloric value of the coal.

Further, yet another aspect of the present invention is to provide a drying technology that may prevent an environment problem resulting from incomplete combustion of coal, by adjusting moisture contained in the coal and a technology that may be applied to a thermal power plant.

### Technical Solution

To achieve the above-described aspects, the present invention may provide an apparatus for reducing dust according to supply of dropping coal in a coal dryer using reheat steam, the coal dryer including a first coal dryer including a pair of first driving sprockets and a pair of first driven sprockets fastened to each other by first chains to be spaced apart from each other by a specific distance, a plurality of first transfer plates hinge-coupled between the first chains, a pair of first guide rails installed below a first upper chain connected between the first driving sprockets and the first driven sprockets to horizontally support first upper transfer plates, a pair of second guide rails installed below a first lower chain connected between the first driving sprockets and the first driven sprockets to horizontally support first lower transfer plates, a first steam chamber installed below the first upper chain to spray reheat steam supplied by a reheater, a second steam chamber installed below the first lower chain to spray the reheat steam supplied by the reheater, a first flue gas chamber installed above the first upper chain to collect flue gas, and a second flue gas chamber installed above the first lower chain to collect flue gas, and a second coal dryer including a pair of second driving sprockets and a pair of second driven sprockets fastened to each other by second chains to be spaced apart from each other by a specific distance, a plurality of second transfer plates hinge-coupled between the second chains, a pair of third guide rails installed below a second upper chain connected between the second driving sprockets and the second driven sprockets to horizontally support second upper transfer plates, a pair of fourth guide rails installed below a second lower chain connected between the second driving sprockets and the second driven sprockets to horizontally support second lower transfer plates, a third steam chamber installed below the second upper chain to spray the reheat steam supplied by the reheater, a fourth steam chamber installed below the second lower chain to spray the reheat steam supplied by the reheater, a third flue gas chamber installed above the second upper chain to collect flue gas, and a fourth flue gas chamber installed above the lower chain to collect flue gas, wherein coal primarily dried by the first coal dryer is input to the second coal dryer to be secondarily dried, the coal dryer further includes a fixed quantity coal supplier configured to supply a specific amount of coal to surfaces of the first transfer plates, which face the upper side, and a dust reducer including an inlet tube coupled to an outlet of the fixed quantity coal supplier by a bearing, a worm wheel coupled to an outer peripheral surface of the inlet tube, a worm gear-coupled to the worm wheel and rotated by rotational force transferred from a motor, a curbed tube, an upper end of which is coupled to the inlet tube, and an outlet tube coupled to an end of the curved tube, and the apparatus including a first flattener configured to uniformly disperse and flatten piles of coal dropped and input from the dust reducer to surfaces of the first upper transfer plates, which face the upper side, and transferred on the surfaces of the first upper transfers plates, a first coal receiver having a plurality of panels fixedly installed between the pair of first driven sprockets radially with respect to a rotary shaft at a specific angle, a second flattener configured to uniformly disperse and flatten the piles of coal dropped and input from the first coal receiver to surfaces of the first lower transfer plates, which face the upper side, through rotation of the first driven sprockets, and transferred on the surfaces of the first lower transfer plates, a third flattener configured to uniformly disperse and flatten the piles of coal dropped and input from the first coal dryer to surfaces of the second upper transfer plates, which face the upper side, of the second coal dryer, and transferred on the surfaces of the second upper transfer plates, a second coal receiver having a plurality of panels installed between the pair of second driven sprockets radially with respect to a rotary shaft at a specific angle, and a fourth flattener configured to uniformly disperse and flatten the piles of coal dropped and input from the second coal receiver to surfaces of the second lower transfer plates, which face the upper side, through rotation of the second driving sprockets, wherein the first coal receiver receives the piles of coal dropped from the surfaces of the first upper transfer plates, is rotated according to the rotation of the first driven sprockets, and then inputs the piles of coal to the surfaces of the first lower transfer plates so as to suppress dust, and the second coal receiver receives the piles of coal dropped from the surfaces of the second upper transfer plates, is rotated according to rotation of the second driven sprockets, and then inputs the piles of coal to the surfaces of the second lower transfer plates so as to suppress dust.

Further, in the present invention, installation angles of the panels of the first coal receiver may be determined such that the piles of coal are dropped and input to a space between the panels after left ends of the first upper transfer plates are separated from the first guide rails, and installation angles of the panels of the second coal receiver may be determined such that the piles of coal are dropped and input to a space between the panels after left ends of the second upper transfer plates are separated from the third guide rails.

Further, the present invention may provide an apparatus for reducing dust according to supply of dropping coal in a coal dryer using reheat steam, the coal dryer including a first coal dryer including a pair of first driving sprockets and a pair of first driven sprockets fastened to each other by first chains to be spaced apart from each other by a specific distance, a plurality of first transfer plates hinge-coupled between the first chains, a pair of first guide rails installed below a first upper chain connected between the first driving sprockets and the first driven sprockets to horizontally support first upper transfer plates, a pair of second guide rails installed below a first lower chain connected between the first driving sprockets and the first driven sprockets to horizontally support first lower transfer plates, a first steam chamber installed below the first upper chain to spray reheat steam supplied by a reheater, a second steam chamber installed below the first lower chain to spray the reheat steam supplied by the reheater, a first flue gas chamber installed above the first upper chain to collect flue gas, and a second flue gas chamber installed above the first lower chain to collect flue gas, and a second coal dryer including a pair of second driving sprockets and a pair of second driven sprockets fastened to each other by second chains to be spaced apart from each other by a specific distance, a plurality of second transfer plates hinge-coupled between the second chains, a pair of third guide rails installed below a second upper chain connected between the second driving sprockets and the second driven sprockets to horizontally support second upper transfer plates, a pair of fourth guide rails installed below a second lower chain connected between the second driving sprockets and the second driven sprockets to horizontally support second lower transfer plates, a third steam chamber installed below the second upper chain to spray the reheat steam supplied by the reheater, a fourth steam chamber installed below the second lower chain to spray the reheat steam supplied by the reheater, a third flue gas chamber installed above the second upper chain to collect flue gas, and a fourth flue gas chamber installed above the lower chain to collect flue gas, wherein coal primarily dried by the first coal dryer is input to the second coal dryer to be secondarily dried, the coal dryer further including a fixed quantity coal supplier configured to supply a specific amount of coal to surfaces of the first transfer plates, which face the upper side, and a dust reducer including an inlet tube coupled to an outlet of the fixed quantity coal supplier by a bearing, a worm wheel coupled to an outer peripheral surface of the inlet tube, a worm gear-coupled to the worm wheel and rotated by rotational force transferred from a motor, a curbed tube, an upper end of which is coupled to the inlet tube, and an outlet tube coupled to an end of the curved tube, and the apparatus including a first flattener configured to uniformly disperse and flatten piles of coal dropped and input from the dust reducer to surfaces of the first upper transfer plates, which face the upper side, and transferred on the surfaces of the first upper transfers plates, a first dust reducer having side plates formed on opposite surfaces of the first dust reducer to have a shape of a flat plate, having a convexo-concave part formed on a surface between upper surfaces of the side plates to have a specific vertical interval, having a shock supporting step protruding upwards from an upper end of the first dust reducer to support bottom surfaces of the first upper transfer plates separated and dropped from the first guide rails, and installed between the first upper transfer plates and the first lower transfer plates to be inclined at a specific angle, a second flattener configured to uniformly disperse and flatten the piles of coal transferred to surfaces of the first lower transfer plates along a surface of the first dust reducer, a third flattener configured to uniformly disperse and flatten the piles of coal dropped and input from the first coal dryer to surfaces of the second upper transfer plates of the second coal dryer, which face the upper side, and transferred on the surfaces of the second upper transfer plates of the second coal dryer, a second dust reducer having side plates formed on opposite surfaces of the first dust reducer to have a shape of a flat plate, having a convexo-concave part formed on a surface between upper surfaces of the side plates to have a specific vertical interval, having a shock supporting step protruding upwards from an upper end of the second dust reducer to support bottom surfaces of the second upper transfer plates separated and dropped from the third guide rails, and installed between the first upper transfer plates and the first lower transfer plates to be inclined at a specific angle, and a fourth flattener configured to uniformly disperse and flatten the piles of coal transferred to surfaces of the second lower transfer plates along a surface of the second dust reducer, wherein the first dust reducer receives the piles of coal dropped from the surfaces of the first upper transfer plates to input the piles of coal to the surfaces of the first lower transfer plates in a sliding manner so as to suppress dust, and the second dust reducer receives the piles of coal dropped from the surfaces of the second upper transfer plates to input the piles of coal to the surfaces of the second lower transfer plates in a sliding manner so as to suppress dust.

Further, in the present invention, each of the first flattener to the fourth flattener may include a column-shaped body, a division boss protruding from a central portion of a front surface of the body and a pair of fixing members configured to fixedly support opposite ends of the body.

Further, the present invention may provide an apparatus for reducing dust according to supply of dropping coal in a coal dryer using reheat steam, the coal dryer including a first coal dryer including a pair of first driving sprockets and a pair of first driven sprockets fastened to each other by first chains to be spaced apart from each other by a specific distance, a plurality of first transfer plates hinge-coupled between the first chains, a pair of first guide rails installed below a first upper chain connected between the first driving sprockets and the first driven sprockets to horizontally support first upper transfer plates, a pair of second guide rails installed below a first lower chain connected between the first driving sprockets and the first driven sprockets to horizontally support first lower transfer plates, a first steam chamber installed below the first upper chain to spray reheat steam supplied by a reheater, a second steam chamber installed below the first lower chain to spray the reheat steam supplied by the reheater, a first flue gas chamber installed above the first upper chain to collect flue gas, and a second flue gas chamber installed above the first lower chain to collect flue gas; and a second coal dryer including a pair of second driving sprockets and a pair of second driven sprockets fastened to each other by second chains to be spaced apart from each other by a specific distance, a plurality of second transfer plates hinge-coupled between the second chains, a pair of third guide rails installed below a second upper chain connected between the second driving sprockets and the second driven sprockets to horizontally support second upper transfer plates, a pair of fourth guide rails installed below a second lower chain connected between the second driving sprockets and the second driven sprockets to horizontally support second lower transfer plates, a third steam chamber installed below the second upper chain to spray the reheat steam supplied by the reheater, a fourth steam chamber installed below the second lower chain to spray the reheat steam supplied by the reheater, a third flue gas chamber installed above the second upper chain to collect flue gas, and a fourth flue gas chamber installed above the lower chain to collect flue gas, wherein coal primarily dried by the first coal dryer is input to the second coal dryer to be secondarily dried, the coal dryer further including a fixed quantity coal supplier configured to supply a specific amount of coal to surfaces of the first transfer plates, which face the upper side, and a dust reducer including an inlet tube coupled to an outlet of the fixed quantity coal supplier by a bearing, a worm wheel coupled to an outer peripheral surface of the inlet tube, a worm gear-coupled to the worm wheel and rotated by rotational force transferred from a motor, a curbed tube, an upper end of which is coupled to the inlet tube, and an outlet tube coupled to an end of the curved tube, and the apparatus including a first flattener configured to uniformly disperse and flatten piles of coal dropped and input from the dust reducer to surfaces of the first upper transfer plates, which face the upper side, and transferred on the surfaces of the first upper transfers plates, a first dust shield having left and right side plates each having a circular arc-shaped first guide hole and a circular arc-shaped second guide hole formed on upper and lower sides of the left and right side plates, having a rear plate integrally coupled to the left and right side plates, having a shock supporting step protruding upwards from an upper end of the rear plate to support bottom surfaces of the first upper transfer plates separated and dropped from the first guide rails, and having a shield compression plate, an upper portion of which is hinge-coupled to a front surface between the left and right side plates and which has first bosses protruding from opposite sides of a central portion of the shield compression plate and inserted into the first guide holes, and has second bosses protruding from opposite sides of a lower portion of the shield compression plate and inserted into the second guide holes, wherein the second bosses are elastically supported by elastic bodies formed at ends of the left and right side plates, a third flattener configured to uniformly disperse and flatten the piles of coal dropped and input from the first coal dryer to surfaces of the second upper transfer plates of the second coal dryer, which face the upper side, and transferred on the surfaces of the second upper transfer plates of the second coal dryer, and a second dust shield having left and right side plates each having a circular arc-shaped first guide hole and a circular arc-shaped second guide hole formed on upper and lower sides of the left and right side plates, having a rear plate integrally coupled to the left and right side plates, having a shock supporting step protruding upwards from an upper end of the rear plate to support bottom surfaces of the second upper transfer plates separated and dropped from the third guide rails, and having a shield compression plate, an upper portion of which is hinge-coupled to a front surface between the left and right side plates and which has first bosses protruding from opposite sides of a central portion of the shield compression plate and inserted into the first guide holes, and has second bosses protruding from opposite sides of a lower portion of the shield compression plate and inserted into the second guide holes, wherein the second bosses are elastically supported by elastic bodies formed at ends of the left and right side plates, wherein the first dust shield receives the piles of coal dropped from the surfaces of the first upper transfer plates to transfer the piles of coal to surfaces of the first lower transfer plates so as to shield dust, and the second dust shield receives the piles of coal dropped from the surfaces of the second upper transfer plates to transfer the piles of coal to the second lower transfer plates so as to shield dust.

Further, in the present invention, a second flattener configured to uniformly disperse and flatten the piles of coal discharged from the first dust shield to the surfaces of the first lower transfer plates and transferred on the surfaces of the first lower transfer plates may be installed, and a fourth flattener configured to uniformly disperse and flatten the piles of coal discharged from the second dust shield to the surfaces of the third lower transfer plates and transferred on the surfaces of the third lower transfer plates may be further installed.

Further, in the present invention, each of the first dust shield and the second dust shield may include an input port formed between the rear plate and the shield compression plate, to which the piles of coal are input, a focusing part configured to focus the input piles of coal using elasticity, and a flattening discharging part configured to uniformly discharge the focused piles of coal to surfaces of transfer plates.

Further, the present invention may provide an apparatus for reducing dust according to supply of dropping coal in a coal dryer using reheat steam, the coal dryer including a first coal dryer including a pair of first driving sprockets and a pair of first driven sprockets fastened to each other by first chains to be spaced apart from each other by a specific distance, a plurality of first transfer plates hinge-coupled between the first chains, a pair of first guide rails installed below a first upper chain connected between the first driving sprockets and the first driven sprockets to horizontally support first upper transfer plates, a pair of second guide rails installed below a first lower chain connected between the first driving sprockets and the first driven sprockets to horizontally support first lower transfer plates, a first steam chamber installed below the first upper chain to spray reheat steam supplied by a reheater, a second steam chamber installed below the first lower chain to spray the reheat steam supplied by the reheater, a first flue gas chamber installed above the first upper chain to collect flue gas, and a second flue gas chamber installed above the first lower chain to collect flue gas, and a second coal dryer including a pair of second driving sprockets and a pair of second driven sprockets fastened to each other by second chains to be spaced apart from each other by a specific distance, a plurality of second transfer plates hinge-coupled between the second chains, a pair of third guide rails installed below a second upper chain connected between the second driving sprockets and the second driven sprockets to horizontally support second upper transfer plates, a pair of fourth guide rails installed below a second lower chain connected between the second driving sprockets and the second driven sprockets to horizontally support second lower transfer plates, a third steam chamber installed below the second upper chain to spray the reheat steam supplied by the reheater, a fourth steam chamber installed below the second lower chain to spray the reheat steam supplied by the reheater, a third flue gas chamber installed above the second upper chain to collect flue gas, and a fourth flue gas chamber installed above the lower chain to collect flue gas, wherein coal primarily dried by the first coal dryer is input to the second coal dryer to be secondarily dried, the coal dryer further including a fixed quantity coal supplier configured to supply a specific amount of coal to surfaces of the first transfer plates, which face the upper side, and a dust reducer including an inlet tube coupled to an outlet of the fixed quantity coal supplier by a bearing, a worm wheel coupled to an outer peripheral surface of the inlet tube, a worm gear-coupled to the worm wheel and rotated by rotational force transferred from a motor, a curbed tube, an upper end of which is coupled to the inlet tube, and an outlet tube coupled to an end of the curved tube, and the apparatus including a first flattener configured to uniformly disperse and flatten piles of coal dropped and input from the dust reducer to surfaces of the first upper transfer plates, which face the upper side, and transferred on the surfaces of the first upper transfers plates, a first deceleration and dust shield having a vertically penetrated square column-shaped body, having a first right inclined plate formed on an upper side of an inner right surface of the body to be inclined to the left lower side at a specific angle, having a first left inclined plate formed on a left surface of the body below the first right inclined plate to be inclined to the right lower side at a specific angle, having a second right inclined plate formed on a right surface below the first left inclined plate to be inclined to the left lower side at a specific angle, having a second left inclined plate formed on the left surface of the body below the second right inclined plate to be inclined to the right lower side at a specific angle, having an outlet formed at a lower portion of the body to be inclined at a specific angle, having an inlet formed at an upper end of the body, and having a shock supporting step protruding upwards form a right upper end of the inlet to support bottom surfaces of the first upper transfer plates separated and dropped from the first guide rails, a third flattener configured to uniformly disperse and flatten the piles of coal dropped and input from the first coal dryer to surfaces of the second upper transfer plates of the second coal dryer, which face the upper side, and transferred on the surfaces of the second upper transfer plates of the second coal dryer, and a first deceleration and dust shield having a vertically penetrated square column-shaped body, having a first right inclined plate formed on an upper side of an inner right surface of the body to be inclined to the left lower side at a specific angle, having a first left inclined plate formed on a left surface of the body below the first right inclined plate to be inclined to the right lower side at a specific angle, having a second right inclined plate formed on a right surface below the first left inclined plate to be inclined to the left lower side at a specific angle, having a second left inclined plate formed on the left surface of the body below the second right inclined plate to be inclined to the right lower side at a specific angle, having an outlet formed at a lower portion of the body to be inclined at a specific angle, having an inlet formed at an upper end of the body, and having a shock supporting step protruding upwards form a right upper end of the inlet to support bottom surfaces of the second upper transfer plates separated and dropped from the third guide rails, wherein the first deceleration and dust shield receives the piles of coal dropped from surfaces of the first upper transfer plates to transfer the piles of coal to surfaces of the first lower transfer plates while the piles of coal are decelerated, so as to shield dust, and the second deceleration and dust shield receives the piles of coal dropped from the surfaces of the second upper transfer plates to transfer the piles of coal to the surfaces of the second lower transfer plates while the piles of coal are decelerated, so as to shield dust.

Further, in the present invention, a second flattener configured to uniformly disperse and flatten the piles of coal discharged from the first deceleration and dust shield to the surfaces of the first lower transfer plates and transferred on the surfaces of the first lower transfer plates may be installed, and a fourth flattener configured to uniformly disperse and flatten the piles of coal discharged from the second deceleration and dust shield to the surfaces of the third lower transfer plates and transferred on the surfaces of the third lower transfer plates may be further installed.

Further, in the present invention, each of the first flattener and the third flattener may include a column-shaped body, a dispersion boss protruding from a central portion of a front surface of the body, and a pair of fixing members configured to fixedly support opposite ends of the body.

Further, in the present invention, a dropping coal decelerator in which left inclined plates and right inclined plates are alternately installed at a specific angle and a specific internal may be formed between an outlet of the first coal dryer and an inlet of the second coal dryer.

Further, in the present invention, each of the second flattener and the fourth flattener may include a column-shaped body, a dispersion boss protruding from a central portion of a front surface of the body, and a pair of fixing members configured to fixedly support opposite ends of the body.

Further, in the present invention, first transfer rollers may be hinge-coupled between centers of opposite sides of each of the first transfer plates and the first chains, respectively, first auxiliary rollers may be hinge-coupled to side surfaces of the first transfer plate on left and right sides of the first transfer rollers, respectively, second transfer rollers may be hinge-coupled between centers of opposite sides of each of the second transfer plates and the second chains, respectively, second auxiliary rollers may be hinge-coupled to side surfaces of the second transfer plate on left and right sides of the second transfer rollers, respectively, first guide bars configured to unidirectionally rotate and upwards support first lower transfer plates separated from the second guide rails may be installed from an upper side via a lateral side to a lower side of the first driving sprockets, second guide bars configured to unidirectionally rotate and downwards support first upper transfer plates separated from the first guide rails may be installed from a lower side via a lateral side to an upper side of the first driven sprockets, third guide bars configured to unidirectionally rotate and upwards support second lower transfer plates separated from the fourth guide rails may be installed from an upper side via a lateral side to a lower side of the second driving sprockets, and fourth guide bars configured to unidirectionally rotate and downwards support second upper transfer plates separated from the third guide rails may be installed from a lower side via a lateral side to an upper side of the second driven sprockets.

Further, in the present invention, a first trigger to a fourth trigger may be coupled to distal ends of the first guide bars to the fourth guide bars, respectively, the first trigger may be installed at a location in contact with sides of bottom surfaces of the first upper transfer plates, the second trigger may be installed at a location in contact with sides of flat surfaces of the first lower transfer plates, the third trigger may be installed at a location in contact with sides of bottom surfaces of the second upper transfer plates, and the fourth trigger may be installed at a location in contact with sides of flat surfaces of the second lower transfer plates.

Further, in the present invention, the first trigger to the fourth trigger may be axially rotating rollers, respectively.

Further, in the present invention, grooves may be formed on surfaces of the first guide rails and the second guide rails to guide rotation of the first transfer rollers and the first auxiliary rollers, and grooves may be formed on surfaces of the third guide rails and the fourth guide rails to guide rotation of the second transfer rollers and the second auxiliary rollers.

Further, in the present invention, an interval between a left end of the second guide rails and a lower end of the first guide bars and an interval between a right end of the first guide rails and an upper end of the second guide bars may be smaller than a width of the first transfer plate, and an interval between a left end of the fourth guide rails and a lower end of the third guide bars and an interval between a left of the third guide rails and an upper end of the fourth guide bars may be smaller than a width of the second transfer plate.

### Advantageous Effects

According to the present invention, piles of coal dropping and input to a coal dryer are supplied and transferred while generation of dust is minimized, so that reliability according to operation of the coal dryer may be improved. In addition, to effectively dry the coal by removing moisture contained in the coal using high temperature reheat steam which is sprayed through a plurality of through-holes penetrated in a plurality of transfer plates while the piles of coal are transferred on the transfer plates, the density of the transferred piles of coal is dispersed, equalized, and flattened, so that the high temperature reheat steam easily comes into contact with coal particles, and thus, moisture remaining inside and outside the coal that is use fuel of a thermal power plant is removed. Accordingly, incomplete combustion of the coal may be prevented, a caloric value of the coal may increase, discharge of pollutants may be minimized, a spontaneous combustion rate may be reduced due to a reduction in the moisture of the coal, and stability of coal supply may be improved by increasing utilization of low grade coal having low demands. Further, low caloric coal that is cheaper than high caloric coal may be used, fuel costs and production costs may be reduced due to a decrease in an import volume of coal, and consumption of the coal may be relatively reduced, so that discharge of wastes and polluted substances generated from combustion gas may be reduced and an amount of generated carbon dioxides may be reduced.

### BRIEF DESCRIPTION OF THE DRAWINGS

FIG. 1 is a block diagram illustrating a coal dryer using reheat steam according to the present invention;

FIG. 2 is a schematic view illustrating a front surface of the coal dryer using reheat steam according to a first embodiment of the present invention;

FIG. 3 is a schematic view illustrating a side surface the coal dryer using reheat steam according to the present invention;

FIG. 4 is a perspective view illustrating a main part of the coal dryer using reheat steam, in which a dust reducer and a flattener configured to disperse and flatten input coal;

FIG. 5 is a perspective view illustrating a state in which a coal receiver is installed in the coal dryer using reheat steam according to the present invention;

FIG. 6 is a perspective view illustrating the coal receiver in the coal dryer using reheat steam according to the present invention;

FIG. 7 is a sectional view illustrating operation of the coal receiver and the flattener configured to flatten input coal according to supply of dropping coal in the coal dryer using reheat steam according to the present invention;

FIG. 8 is a schematic view illustrating a front surface of a coal dryer using reheat steam according to a second embodiment of the present invention;

FIG. 9 is a perspective view illustrating a main portion of the coal dryer using reheat steam according to the present invention, in which a dust suppressor is installed;

FIG. 10 is a perspective view illustrating the dust suppressor in the coal dryer using reheat steam according to the present invention;

FIG. 11 is a sectional view illustrating operation of the dust suppressor and the flattener configured to disperse and flatten input coal according to supply of dropping coal in the coal dryer using reheat steam according to the present invention;

FIG. 12 is a schematic view illustrating a front surface of the coal dryer using reheat steam according to a third embodiment of the present invention;

FIG. 13 is a perspective view illustrating a main portion of the coal dryer using reheat steam according to the present invention, in which a dust shield is installed;

FIG. 14 is a perspective view illustrating the dust shield in the coal dryer using reheat steam according to the present invention;

FIGS. 15 and 16 are sectional views illustrating operation of the dust shield and the flattener configured to disperse and flatten input coal according to transfer of dropping coal in the coal dryer using reheat steam according to the present invention;

FIG. 17 is a schematic view illustrating a front surface of a coal dryer using reheat steam according to a fourth embodiment of the present invention;

FIG. 18 is a perspective view illustrating a main portion of the coal dryer using reheat steam according to the present invention, in which a deceleration and dust shield is installed;

FIG. 19 is a perspective view illustrating the deceleration and dust shield in the coal dryer using reheat steam according to the present invention;

FIG. 20 is a sectional view illustrating operation of the deceleration and dust shield and the flattener configured to disperse and flatten input coal according to transfer of dropping coal in the coal dryer using reheat steam according to the present invention;

FIG. 21 is a schematic view illustrating a front surface of a coal dryer using reheat steam according to a fifth embodiment of the present invention;

FIG. 22 is a perspective view illustrating a main portion a transfer device in the coal dryer using reheat steam according to the present invention;

FIGS. 23 and 24 are perspective views illustrating a portion of a transfer device in the coal dryer using reheat steam according to the present invention; and

FIGS. 25 and 26 are sectional views illustrating operation of the transfer device in the coal dryer using reheat steam according to the present invention.

### BEST MODE FOR THE INVENTION

Hereinafter, an apparatus for reducing dust according to supply of dropping coal in a coal dryer using reheat steam according to the present invention will be described in detail with reference to the accompanying drawings.

The present invention is to suppress, shield and reduce generation of dust from coal dropping and input during transfer within a transfer device such as a conveyor and a transfer plate, when the coal is dried while the coal is transferred using the transfer device. In addition, the apparatus for reducing dust is installed in the coal dryer configured to minimize generation of dust when the dried coal drops and is input to a next coal dryer while the dried coal is transferred to the transfer plate.

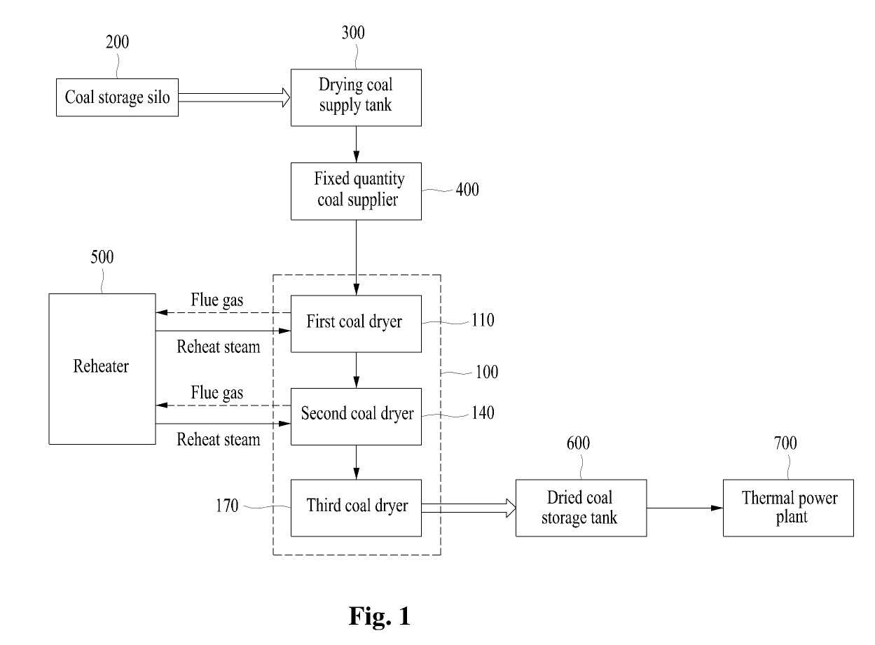

In FIG. 1, a coal storage silo 200 is a place where coal used for fuel of a boiler of a thermal power plant is stored. The coal contains surface moisture and internal moisture. In addition, the coal stored in the coal storage silo 200 is prevented from being scattered, by periodically spraying water. The coal stored in the coal storage silo 200 is transferred to a coal dryer 100 through a transfer unit such as a conveyor system. Here, coal in the coal storage silo 200, from which moisture is not removed, may be moved to and stored in a coal supply tank 300 for drying that is connected to the coal dryer. Further, the coal stored in the coal supply tank 300 is supplied from a fixed quantity coal supplier 400 to the coal dryer 100 at a fixed quantity. The coal dryer 100 includes a third coal dryer 170 for drying coal that is discharged through a first coal dryer 110 and a second coal dryer 140 that are installed in multiple layers. The first coal dryer 110 and the second coal dryer 140 are configured to have approximately the same structure. The coal naturally dried via the third coal dryer 170 is temporarily stored in a dried coal storage tank 600 and is then supplied as fuel of a boiler of a thermal power plant 700.

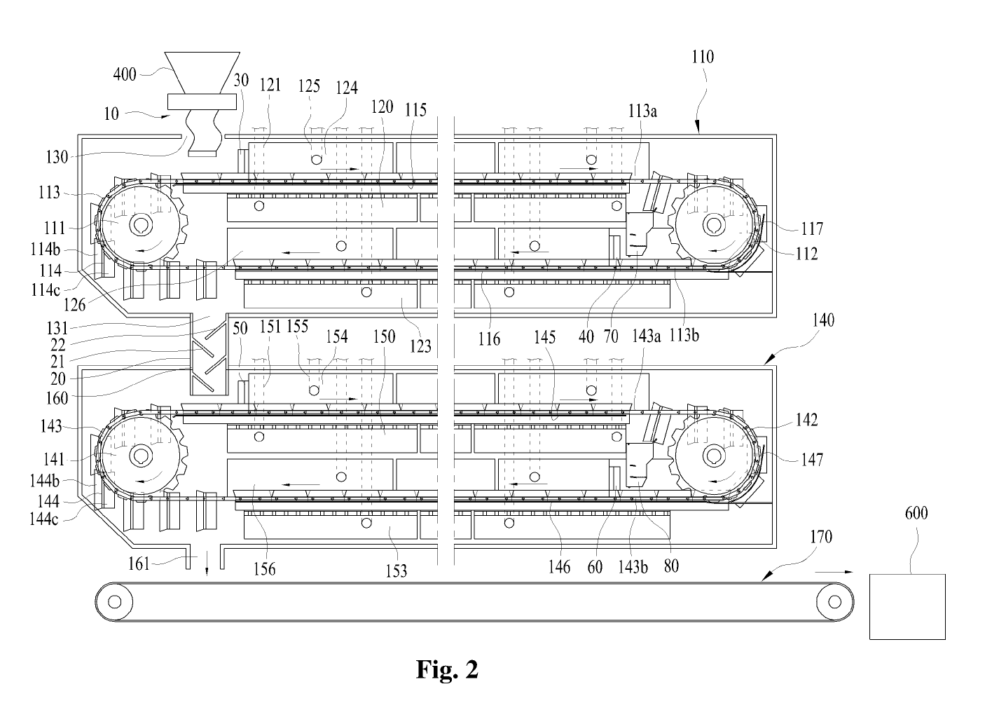

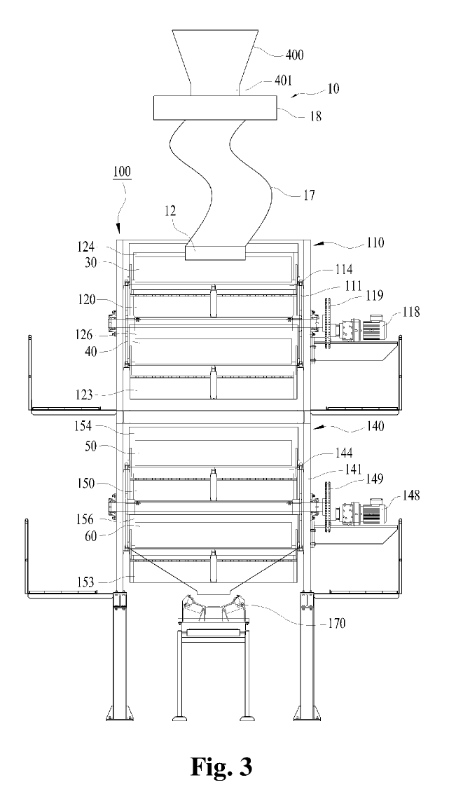

In FIGS. 2 to 4, the coal dryer 100 includes a multiple stage dryer that dries coal input from the fixed quantity coal supplier 400, that is, the first coal dryer 110, the second coal dryer 140 that secondarily dries the coal dried by the first coal dryer, and the third coal dryer 170 that supplies the coal dried by the second coal dryer to the dry coal storage tank 600 after the coal is naturally dried.

The first coal dryer 110 includes a pair of first driving sprockets 111 and a pair of first driven sprockets 112 fastened to each other by first chains 113 to be spaced apart from each other by a specific distance, a plurality of first transfer plates 114 that are hinge-coupled to each other between the first chains 113, a pair of first guide rails 115 installed below an second upper chain 113a connected between the first driving sprockets 111 and the first driven sprockets 112 to horizontally support the first transfer plates 114, a pair of second guide rails 116 installed below a first lower chain 113b connected between the first driving sprockets 111 and the first driven sprockets 112 to horizontally support the first transfer plates 114, a first steam chamber 120 installed below the first upper chain 113a to spray reheat steam supplied by a reheater 500, a second steam chamber 123 installed below the first lower chain 113b to spray the reheat steam supplied by the reheater 500, a first flue gas chamber 124 installed above the first upper chain 113a to collect flue gas, and a second flue gas chamber 126 installed above the first lower chain 113 to collect flue gas.

Further, the second coal dryer 140 includes a pair of second driving sprockets 141 and a pair of second driven sprockets 142 fastened to each other by second chains 143 to be spaced apart from each other by a specific distance, a plurality of second transfer plates 144 hinge-coupled to each other between the second chains 143, a pair of third guide rails 145 installed below a second upper chain 143a connected between the second driving sprockets 141 and the second driven sprockets 142 to horizontally support the second upper transfer plate 144, a pair of fourth guide rails 146 installed below a second lower chain 143b connected between the second driving sprockets 141 and the second driven sprockets 142 to horizontally support the second transfer plates 144, a third steam chamber 150 installed below the second upper chain 143a to spray reheat steam supplied by the reheater 500, a fourth steam chamber 153 installed below the second lower chain 143b to spray the reheat steam supplied by the reheater 500, a third flue gas chamber 154 installed above the second upper chain 143a to collect flue gas, and a fourth flue gas chamber 156 installed above the second lower chain 143b to collect flue gas.

Further, a plurality of through-holes 114a are formed in the first transfer plates 114 such that the reheat steam sprayed in the first steam chamber 120 and the second steam chamber 123 comes into contact with coal particles by passing through the first transfer plates 114. Guards 114b having a specific height are installed at left and right sides of top surfaces of the first transfer plates 114 such that piles of the input coal do not flow down to left sides or right sides of the first transfer plate 114. The guards 114b have an approximately trapezoidal shape, an upper portion of which is wide and a lower portion of which is narrow. Thus, upper portions of the guards 114b of the first transfer plates 114, which are adjacent to each other, overlap each other. Here, it is preferable that the guards 114b of the first transfer plates 114, which are adjacent to each other, are installed in an approximately zigzag direction. Further, shielding plates 114c are installed at left and right sides of bottom surfaces of the first transfer plates 114 such that the reheat steam sprayed in the first steam chamber 120 and the second steam chamber 123 is not dissipated due to spraying thereof to left and right sides of the first steam chamber 120 and the second steam chamber 123, respectively.

Further, a plurality of through-holes 144a are formed in the second transfer plates 144 such that reheat steam sprayed in the third steam chamber 150 and the fourth steam chamber 153 comes into contact with coal particles by passing through the second transfer plates 144. Guards 144b having a specific height are installed at left and right sides of top surfaces of the second transfer plates 144 such that the piles of the input coal do not flow down to left sides or right sides of the second transfer plates 144. The guards 144b have an approximately trapezoidal shape, an upper portion of which is wide and a lower portion of which is narrow. Thus, upper portions of the guards 144b of the second transfer plates 144, which are adjacent to each other, overlap each other. Here, it is preferable that the guards 144b of the second transfer plates 144, which are adjacent to each other, are installed in an approximately zigzag direction. Further, shielding plates 144c are installed at left and right sides of bottom surfaces of the second transfer plates 144 such that the reheat steam sprayed in the third steam chamber 150 and the fourth steam chamber 153 is not dissipated due to spraying thereof to left and right sides of the third steam chamber 150 and the fourth steam chamber 153, respectively.

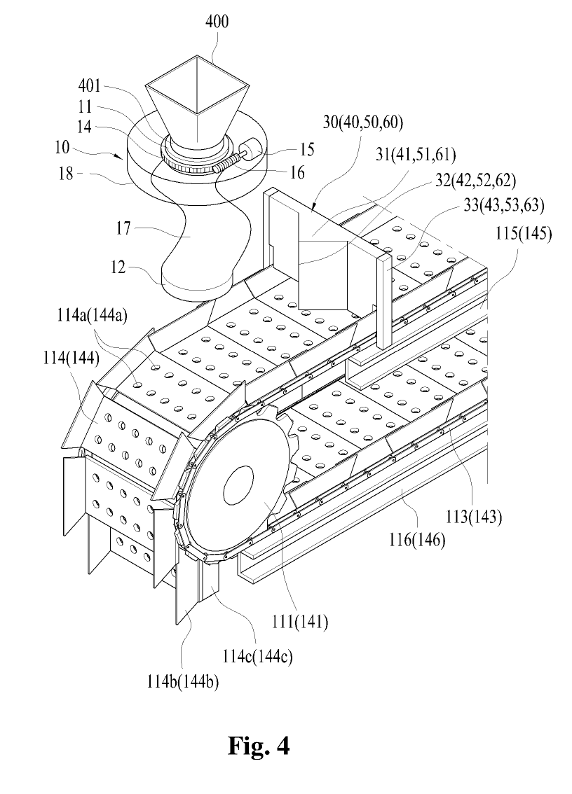

In FIG. 4, a dust reducer 10 is installed at a lower end of the fixed quantity coal supplier 400. The dust reducer 10 is installed to be spaced apart from surfaces of the plurality of first transfer plates 114 of the first coal dryer 110, which face the upper side, by a specific interval.

An inlet tube 11 of the dust reducer 10 is coupled to an outlet 401 of the fixed quantity coal supplier 400 through a bearing. A worm wheel 14 is coupled to an outer peripheral surface of the inlet tube 11. A worm 15 is engaged with a gear formed on an outer peripheral surface of the worm wheel 14. The worm 15 is gear-coupled to the worm wheel 14 and is rotated by rotational force transferred from a motor 16 at a specific speed. The worm wheel 14 is engaged with the worm 15 at a specific gear ratio, and the worm wheel 14 reduces a rotation speed of the worm 15. The motor 16, which generates rotational force in a specific direction, may be forwards rotated or reversely rotated. An upper end of a curved tube 17 is coupled to the inlet tube 11. The curved tube 17 is bent in a specific direction. Any one of a zigzag shape, a twist shape and a spiral shape may be applied to a tube cross section of the curved tube 17. The curved tube 17 may change a direction of the coal supplied by the fixed quantity coal supplier 400 to reduce a speed at which the coal is supplied. In addition, it is preferable that the curved tube 17 is bent or twisted in at least two times. An outlet tube 12 is coupled to an end of the curved tube 17. A direction in which the coal is input onto the first transfer plates 114 is determined by the outlet tube 12. Further, it is preferable that the inlet tube 11 and the outlet tube 12 are installed approximately on the same central axis.

In addition, the dust reducer 10 rotates the coal supplied by the fixed quantity coal supplier 400 at a specific amount in a specific direction, to reduce a speed at which the coal drops to the surfaces of the first transfer plates, which face the upper side, so as to suppress generation of dust.

Further, the first flattener 30 includes a column-shaped body 31, a division boss 32 protruding from a center of a front surface of the body, and a pair of fixing members 33 fixedly supporting opposite ends of the body 31. That is, the flattener 30 includes the column-shaped body 31. A surface of the body 31, through which coal may be uniformly dispersed on the transfer device, may have a polygonal shape or an elliptical shape. Further, the division boss 32 configured to divide and disperse a center of the transferred piles of coal into left and right parts protrudes from the center of the front surface of the body 31. The division boss 32 has an approximately triangular column shape and has an edge having an intersection line on a front side of the body 31. Thus, when the piles of coal come into contact with the division boss 32, coal particles are divided into opposite left and right sides by the division boss 32. Thus, the division boss 32 functions to divide and disperse the center of the piles of coal into left and right parts and flatten the piles of coal as well. Opposite ends of the body 31 having the division boss 32 protruding therefrom are fixedly supported by the pair of fixing members 33 fixed to one side of the transfer device. Further, the first flattener 30 flattens the piles of coal, which are transferred by the transfer device, at a specific height, so that the reheat steam sprayed while passing through the transfer device uniformly comes into contact with surfaces of the coal particles.

In addition, second to fourth flatteners 40, 50 and 60 also have the same configuration and structure as those of the first flattener 30.

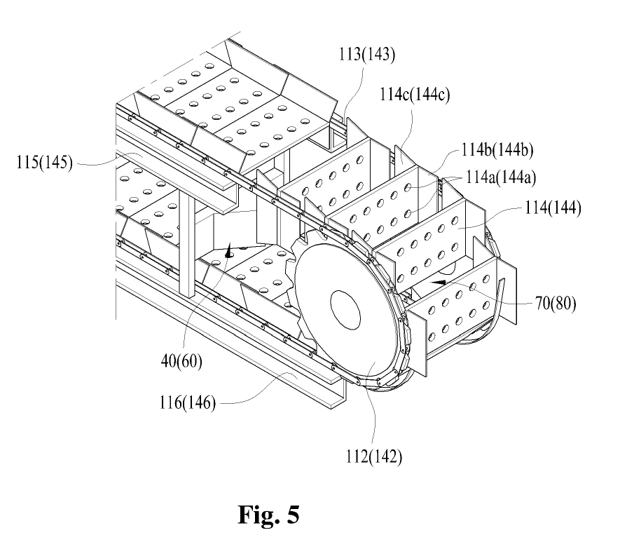

A first embodiment of the apparatus for reducing dust according to supply of dropping coal in the coal dryer using reheat steam according to the present invention will be described in detail with reference to FIGS. 5 to 7.

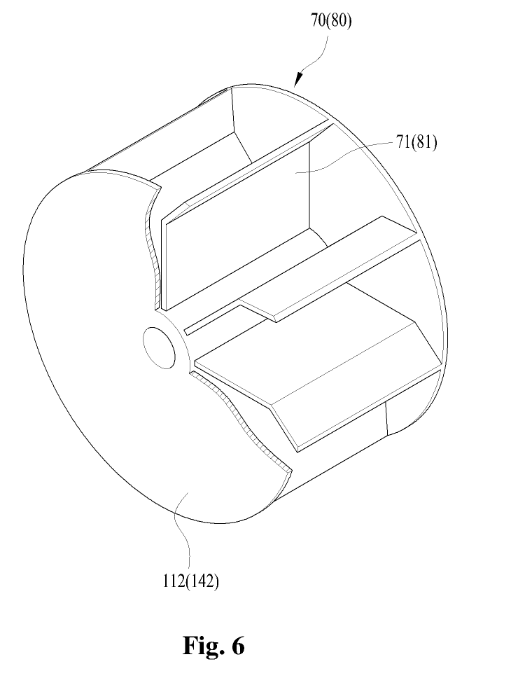

First, in FIGS. 5 and 6, a first coal receiver 70 includes a plurality of panels 71 fixedly installed between the pair of first driven sprockets 112 radially with respect to a rotary shaft at a specific angle. An installation angle of the panels 71 of the first coal receiver 70 is determined such that the piles C of coal drop and is input to a space formed between the panels after a left end of the first transfer plate 114 is separated from the first guide rail 115. In addition, upper ends of the panels 71 are bent approximately in a right direction, so that when one side of the first transfer plate 114 is separated from the first guide rail 115 and the piles of coal drop, a shock may be absorbed, and the piles C of coal loaded on the first transfer plate 114 may be gently input to the space between the panels as well. Further, the first coal receiver 70 is rotated in conjunction with rotation of the first driven sprockets 112 such that the piles C of coal are input onto the surface of the first transfer plate 114 moved to the lower side without generation of dust.

The second flattener 40 horizontally divides, disperses and flattens a center of the piles C of the coal dropping from the first coal receiver 70 onto the surface of the first transfer plate, which faces the upper side, through rotation of the first driven sprockets 112, and transferred on the surface of the first transfer plate.

A dropping coal decelerator 20 in which left inclined plates 21 and right inclined plates 22 are alternately installed at a specific angle and a specific interval is formed between an outlet 131 of the first coal dryer 110 and an inlet 160 of the second coal dryer 140. In the dropping coal decelerator 20, when the piles of coal dried by the first coal dryer 110 are input to the second coal dryer 140, the piles of coal are decelerated while downwards moving along the plurality of left inclined plates 21 and the plurality of right inclined plates 22. In addition, generation of dust is suppressed while the piles of coal drop along the left inclined plates 21 and the right inclined plates 22. Further, because a lower end of the dropping coal decelerator 20 extends down to a location that is adjacent to the surface of the second transfer plate 144 of the second coal dryer 140, generation of dust is minimized while the piles of coal passing through the dropping coal decelerator 20 are input onto the surface of the second transfer plate 144 of the second coal dryer 140.

Further, the third flattener 50 horizontally divides, disperses and flattens a center of the piles C of the coal that drop from the dropping coal decelerator 20 onto the surfaces of the second transfer plates 144, which face the upper side, and are transferred on the surfaces of the second transfer plates 144.

Further, a second coal receiver 80 includes a plurality of panels 81 fixedly installed between the pair of first driven sprockets 142 radially with respect to a rotary shaft at a specific angle. An installation angle of the panels 81 of the second coal receiver 80 is determined such that the piles C of coal drop and is input to a space formed between the panels after a left end of the second transfer plate 144 is separated from the first guide rail 145. In addition, upper ends of the panels 81 are bent approximately in a right direction, so that when one side of the second transfer plate 144 is separated from the first guide rail 145 and the piles of coal drop, a shock may be absorbed, and the piles C of coal loaded on the second transfer plate 144 may be gently input to the space between the panels as well. Further, the second coal receiver 80 is rotated in conjunction with rotation of the second driven sprockets 142 such that the piles C of coal are input onto the surface of the second transfer plate 144 moved to the lower side without generation of dust.

The fourth flattener 60 horizontally divides, disperses and flattens a center of the piles C of the coal dropping from the second coal receiver 80 onto the surface of the second transfer plate, which faces the upper side, through rotation of the second driven sprockets 142, and transferred on the surface of the first transfer plate.

Thus, in an apparatus for reducing dust according to supply of dropping coal in the coal dryer according to the present invention, when the coal that is input by the fixed quantity coal supplier 400 at a fixed quantity is input onto and are transferred on the surface of the first upper transfer plate 114 of the first coal dryer 110 via the dust reducer 10, the first flattener 30 uniformly disperses and flattens the transferred piles of coal. Further, after the piles of coal are dried by the reheat steam while being transferred on the first upper transfer plate 114, the piles of coal loaded on the first transfer plates 114 drop onto the first coal receiver 70 installed inside the first driven sprockets 112.

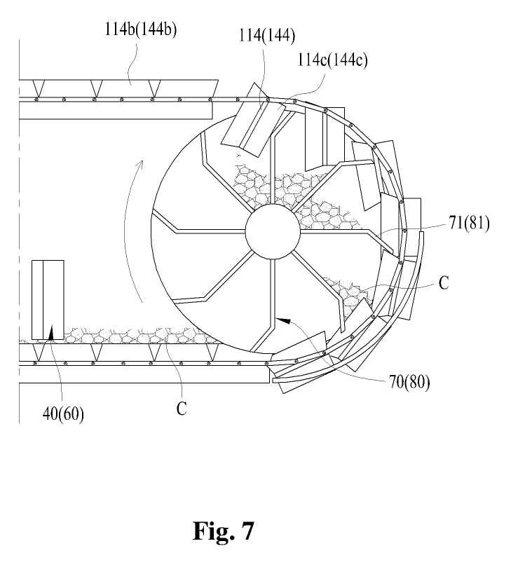

In FIG. 7, the first coal receiver 70 inputs the piles of coal onto the surface of the first lower transfer plate 114 while rotating, and the piles of coal, which are input to the first lower transfer plate 114, are uniformly dispersed and flattened through the second flattener 40. Further, the piles of coal loaded on the first lower transfer plate 114 are dried by the reheat steam while being transferred.

Further, after a dropping speed of the piles of coal completely dried by the first coal dryer 110 decreases while the piles of coal pass through the dropping coal decelerator 20 installed between the first coal dryer 110 and the second coal dryer 140, and generation of dust is suppressed as well, when the piles of coal are input onto and transferred on the surface of the second upper transfer plate 144 of the second coal dryer 140, the third flattener 50 uniformly disperses and flattens the transferred piles of coal. Further, after the piles of coal are dried by the reheat steam while being transferred on the second lower transfer plate 144, the piles of coal loaded on the second transfer plate 144 drop onto the second coal receiver 80 installed inside the second driven sprockets 142. The second coal receiver 80 inputs the piles of coal onto the surface of the second lower transfer plate 144 while rotating, and the piles of coal, which are input to the second lower transfer plate 144, are uniformly dispersed and flattened through the fourth flattener 60. Further, the piles of coal loaded on the second lower transfer plate 144 are dried by the reheat steam while being transferred.

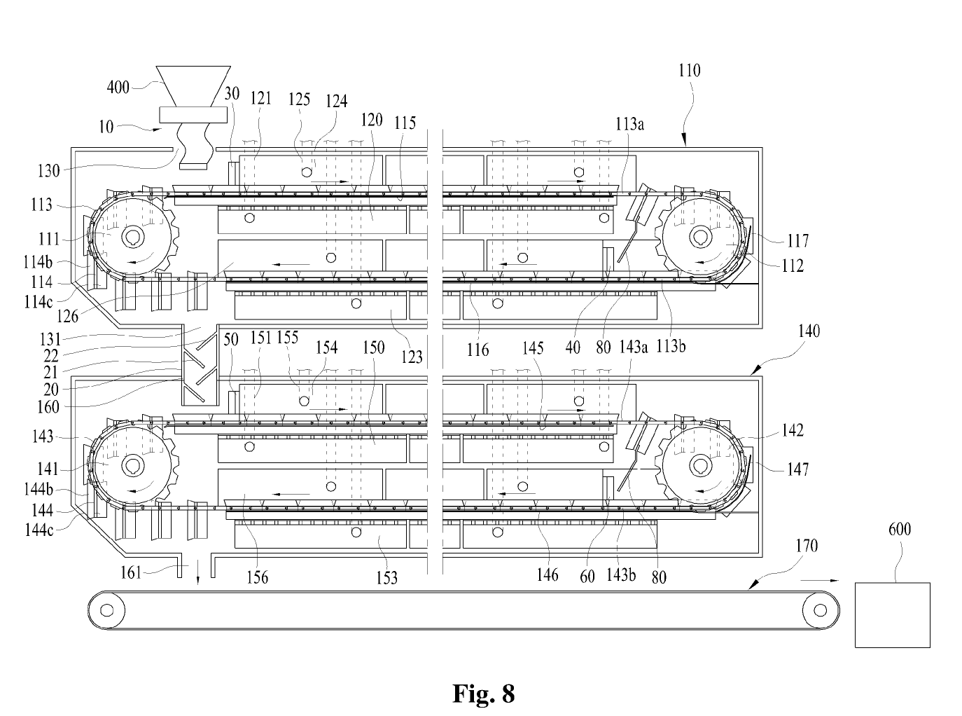

Next, a second embodiment of the apparatus for reducing dust according to supply of dropping coal in the coal dryer using reheat steam according to the present invention will be described in detail with reference to FIGS. 8 to 11.

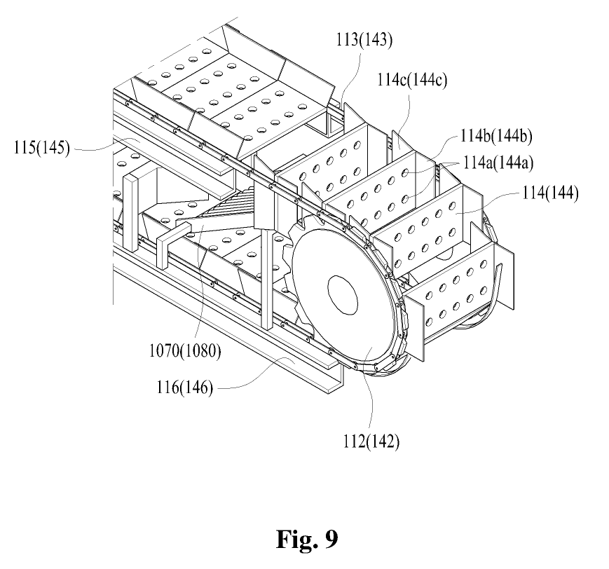

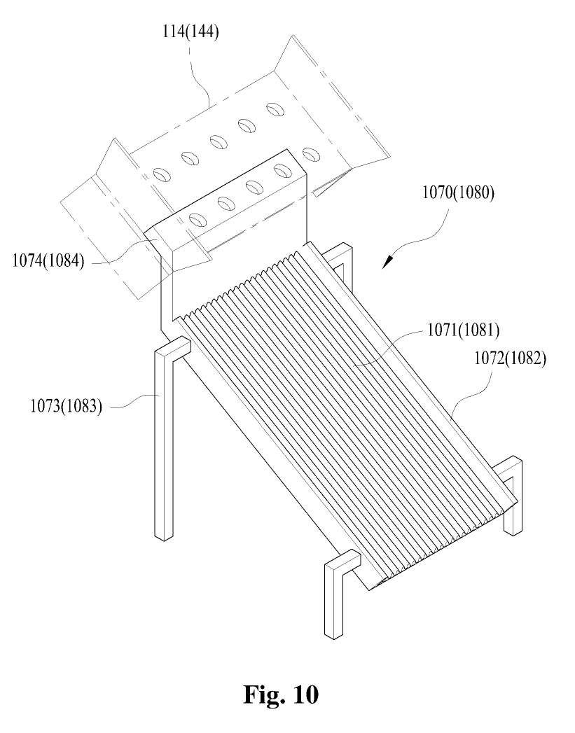

First, in FIGS. 9 and 10, a first dust suppressor 1070 has a shape of an approximately flat plate. A convexo-concave part 1071 in which a plurality of convex parts and a plurality of concave parts are continuously and vertically formed at a specific interval is formed on a surface of the first dust suppressor 1070. Side plates 1072 having a specific height protrude from opposite edges of the first dust suppressor 1070. The side plates 1072 prevent the piles of coal transferred along the convexo-concave part 1071 from overflowing to a left side or a right side of the first dust suppressor 1070. A shock supporting step 1074 supporting a bottom surface of the first upper transfer plate 114 separated and dropping from the first guide rail 115 protrudes upwards from an upper end of the first dust suppressor 1070. The shock supporting step 1074, which is in contact with the bottom surface of the first upper transfer plate 114, smoothly comes into contact with the bottom surfaces of the first transfer plates 114 at an approximately specific angle when a left portion of the first upper transfer plate 114 is inclined at a specific angle after being separated from the first guide rail 115. While the first transfer plates 114 are transferred to the first driven sprockets 112 along the first chains 113, the piles of coal loaded on the surfaces of the first transfer plates drop to the surface of the first dust suppressor 1070. Thereafter, the first transfer plates 114 climb up the shock supporting step 1074 through rotation of the first driven sprockets 112, opposite ends of the first dust suppressor 1070 are fixedly supported by a plurality of fixing members 1073 fixed to one side of the transfer device.

In addition, the first dust suppressor 1070 is inclined between the first transfer plates 114 of the first coal dryer, that is, between the first upper transfer plate 114 and the first lower transfer plate 114 at a specific angle. It is preferable that an inclined installation angle of the first dust suppressor 1070 is an angle at which generation of dust that may be generated from the piles of coal downwards sliding from the surfaces of the first transfer plates 114 may be minimized, that is, approximately 45 degrees.

The second flattener 40 horizontally divides, disperses and flattens a center of the piles C of the coal that drop and input from the first dust suppressor 1070 to the surface of the first lower transfer plate, which faces the upper side, and are transferred on the surface of the first lower transfer plate. This is to transfer the piles of coal transferred through the first dust suppressor 1070 after the piles of coal are uniformly dispersed and flattened on the surface of the first lower transfer plate 114 because the piles of coal are irregularly stacked on each other.

Next, the dropping coal decelerator 20 in which left inclined plates 21 and right inclined plates 22 are alternately installed at a specific angle and a specific interval is formed between the outlet 131 of the first coal dryer 110 and the inlet 160 of the second coal dryer 140. In the dropping coal decelerator 20, when the piles of coal dried by the first coal dryer 110 are input to the second coal dryer 140, the piles of coal are decelerated while downwards moving along the plurality of left inclined plates 21 and the plurality of right inclined plates 22. In addition, generation of dust is suppressed while the piles of coal drop along the left inclined plates 21 and the right inclined plates 22. Further, because a lower end of the dropping coal decelerator 20 extends down to a location that is adjacent to the surface of the second transfer plate 144 of the second coal dryer 140, generation of dust is minimized while the piles of coal passing through the dropping coal decelerator 20 are input onto the surface of the second transfer plate 144 of the second coal dryer 140.

Further, the third flattener 50 horizontally divides, disperses and flattens a center of the piles C of the coal that drop from the dropping coal decelerator 20 onto the surfaces of the second transfer plates 144, which face the upper side, and are transferred on the surfaces of the second transfer plates 144. This is to transfer the piles of coal transferred from the dropping coal decelerator 20 after the piles of coal are uniformly dispersed and flattened on the surface of the second transfer plate 144 because the piles of coal are irregularly stacked on each other.

Further, a second dust suppressor 1080 has a shape of an approximately flat plate. A convexo-concave part 1081 in which a plurality of convex parts and a plurality of concave parts are continuously and vertically formed at a specific interval is formed on a surface of the second dust suppressor 1080. Side plates 1082 having a specific height protrude from opposite edges of the second dust suppressor 1080. The side plates 1082 prevent the piles of coal transferred along the convexo-concave part 1071 from overflowing to a left side or a right side of the second dust suppressor 1080. A shock supporting step 1084 supporting a bottom surface of the second upper transfer plate 144 separated and dropping from the third guide rail 145 protrudes upwards from an upper end of the first dust suppressor 1080. The shock supporting step 1084, which is in contact with the bottom surface of the second upper transfer plate 144, smoothly comes into contact with the bottom surfaces of the second transfer plates 144 at an approximately specific angle when a left portion of the second upper transfer plate 144 is inclined at a specific angle after being separated from the third guide rail 145. While the second transfer plates 144 are transferred to the first driven sprockets 142 along the second chains 143, the piles of coal loaded on the surfaces of the second transfer plates 144 drop to the surface of the first dust suppressor 1080. Thereafter, the second transfer plates 144 climb up the shock supporting step 1084 through rotation of the second driven sprockets 142, opposite ends of the first dust suppressor 1070 are fixedly supported by the plurality of fixing members 1073 fixed to one side of the transfer device.

The second dust suppressor 1080 is inclined between the second transfer plates 144 of the second coal dryer, that is, between the second upper transfer plate 144 and the second lower transfer plate 144 at a specific angle. It is preferable that an inclined installation angle of the second dust suppressor 1080 is an angle at which generation of dust that may be generated from the piles of coal downwards sliding from the surfaces of the second transfer plates 144 may be minimized, that is, approximately 45 degrees.

The fourth flattener 60 horizontally divides, disperses and flattens a center of the piles C of the coal that drop and input from the second dust suppressor 1080 to the surface of the first lower transfer plate, which faces the upper side, and are transferred on the surface of the first lower transfer plate. This is to transfer the piles of coal transferred through the second dust suppressor 1080 after the piles of coal are uniformly dispersed and flattened on the surface of the second lower transfer plate 144 because the piles of coal are irregularly stacked on each other.

Thus, in an apparatus for suppressing dust according to supply of dropping coal in the coal dryer according to the present invention, when the coal that is input by the fixed quantity coal supplier 400 at a fixed quantity is input onto and are transferred on the surface of the first upper transfer plate 114 of the first coal dryer 110 via the dust reducer 10, the first flattener 30 uniformly disperses and flattens the transferred piles of coal. Further, after the piles of coal are dried by the reheat steam while being transferred on the first upper transfer plate 114, the piles of coal loaded on the first transfer plates 114 drop onto the surface of the first dust suppressor 1070.

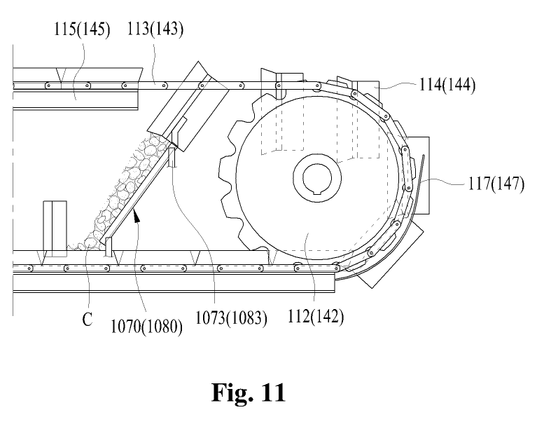

In FIG. 11, the piles of coal input onto the surface of the first dust suppressor 1070 installed at a specific inclined angle slide downwards and are then input to the surface of the first lower transfer plate 114. The piles of coal input onto the first lower transfer plate 114 are uniformly dispersed and flattened while passing through the second flattener 40. Further, the piles of coal loaded on the first lower transfer plate 114 are dried by the reheat steam while being transferred.

Further, after a dropping speed of the piles of coal completely dried by the first coal dryer 110 decreases while the piles of coal pass through the dropping coal decelerator 20 installed between the first coal dryer 110 and the second coal dryer 140, and generation of dust is suppressed as well, when the piles of coal are input onto and transferred on the surface of the second upper transfer plate 144 of the second coal dryer 140, the third flattener 50 uniformly disperses and flattens the transferred piles of coal. Further, after the piles of coal are dried by the reheat steam while being transferred on the second upper transfer plate 144, the piles of coal loaded on the second upper transfer plate 144 drop onto the surface of the second dust suppressor 1080. The piles of coal input onto the surface of the second dust suppressor 1080 installed at a specific inclined angle slide downwards and are then input onto the surface of the first lower transfer plate 144. The piles of coal input onto the second lower transfer plate 144 are uniformly dispersed and flattened while passing through the fourth flattener 60. Further, the piles of coal loaded on the second lower transfer plate 144 are dried by the reheat steam while being transferred.

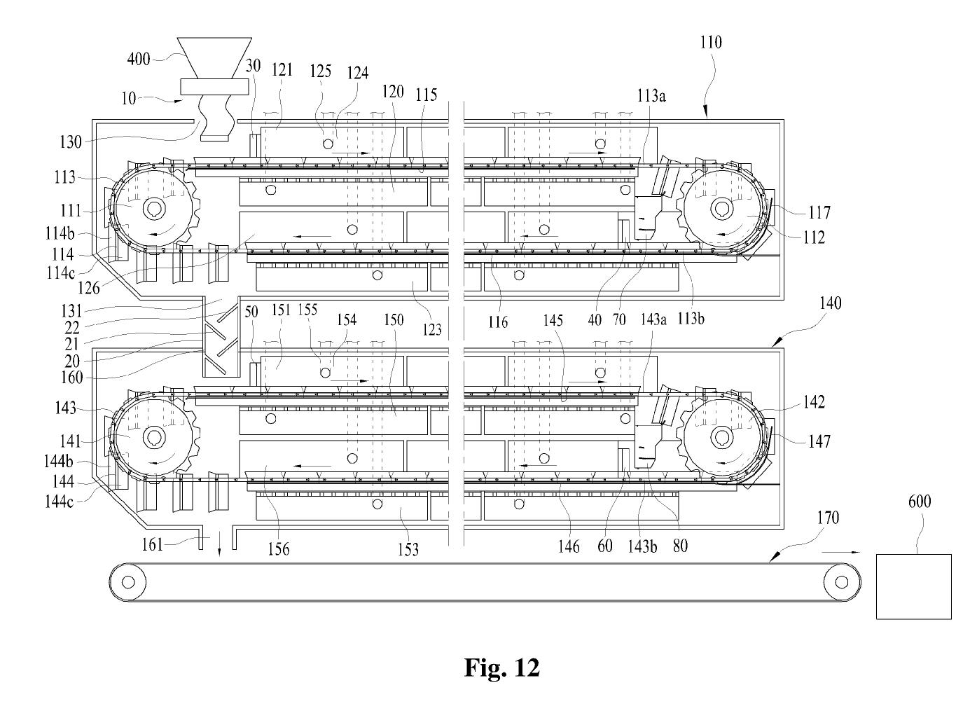

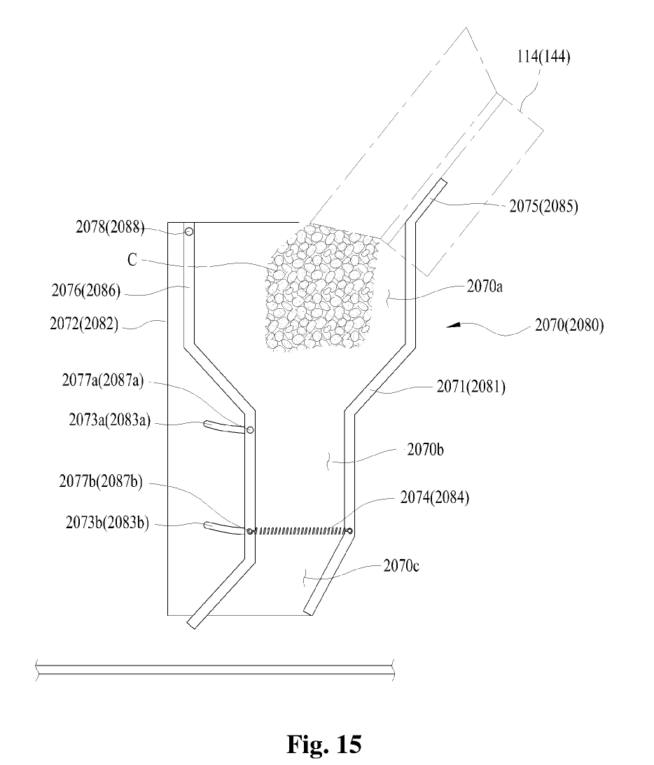

Next, a third embodiment of the apparatus for reducing dust according to supply of dropping coal in the coal dryer using reheat steam according to the present invention will be described in detail with reference to FIGS. 12 to 16.

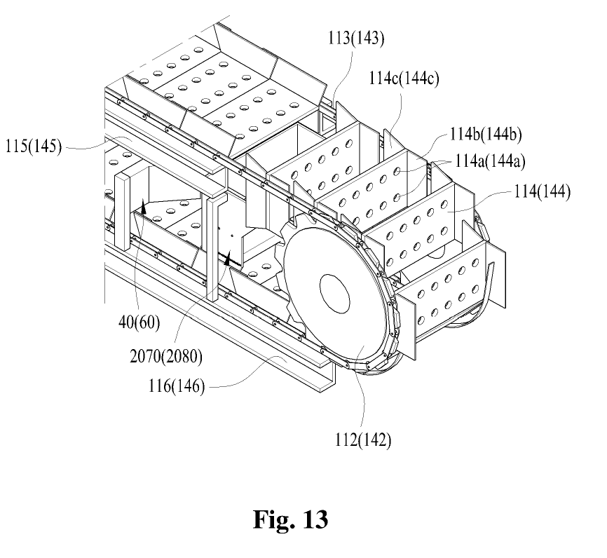

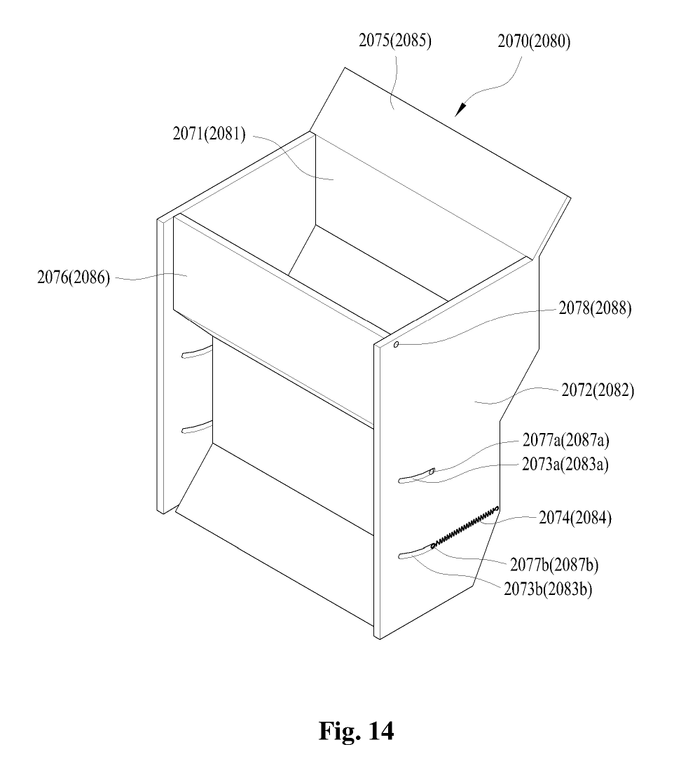

First, in FIGS. 13 and 14, a first dust shield 2070 has a shape of an approximately square column. Side plates 2072 on left and right sides of the first dust shield 2070 are integrally coupled to a rear plate 2071. The rear plate 2071 is inwards inclined as it goes from the upper side to the lower side. Circular arc-shaped first guide holes 2073a are formed through central portions of the side plates 2072 coupled to the rear plate 2071, and circular arc-shaped second guide holes 2073b are formed through lower portions of the side plates 2072. Further, a shock supporting step 2075 protrudes upwards from an upper end of the rear plate 2071. The shock supporting step 2075 supports a bottom surface of the first upper transfer plate 114 separated and dropping from the first guide rail 115. The shock supporting step 2075, which is in contact with the bottom surface of the first upper transfer plate 114, smoothly comes into contact with the bottom surfaces of the first transfer plates 114 at an approximately specific angle when a left portion of the first upper transfer plate 114 is inclined at a specific angle after being separated from the first guide rail 115.

Further, a shield compression plate 2076 is coupled to a front surface between the left and right side plates 2072 of the first dust shield 2070. That is, upper side surfaces of the shield compression plate 2076 are coupled by hinges. Further, first bosses 2077a protrude from opposite surfaces of a central portion of the shield compression plate 2076 and are inserted into the first guide holes 2073a, respectively, and second bosses 2077b protrude from opposite surfaces of a lower portion of the shield compression plate 2076 and are inserted into the second guide holes 2073b, respectively. In addition, the second bosses 2077b inserted into the second guide holes 2073b are elastically supported by elastic bodies 2074 at ends of the left and right side plates 2072, respectively. It is preferable that tension springs are applied to the elastic bodies 2074. The shield compression plate 2076 is inwards inclined as it goes from the upper side to the lower side, which is like the rear plate 2071. Thus, due to coupling between the shield compression plate 2076 and the rear plate 2071 to which the left and right side plates 2072 are integrally coupled, when the piles of coal are input from the upper side, the piles of coal are collected in the inner lower side, and are then dispersed and discharged onto the surface of the first lower transfer plate 114 at a fixed quantity. Here, the shield compression plate 2076 coupled to upper portions of the left and right side plates 2072 by hinges 2078 slightly decelerates discharge of coal by elastic force of the elastic bodies 2074 coupled to the second bosses 2077b. Further, it is preferable that the elastic force of the elastic bodies 2074 is determined based on a weight of the piles of coal. Opposite ends of the first dust shield 2070 are fixedly supported by a plurality of fixing members 2079 fixed to one side of the transfer device.

In addition, the first dust shield 2070 is installed between the first transfer plates 114 of the first coal dryer, that is, between the first upper transfer plate 114 and the first lower transfer plate 114 approximately in a vertical direction.

The second flattener 40 horizontally divides, disperses and flattens a center of the piles C of the coal that drop and input from the first dust shield 2070 to the surface of the first lower transfer plate, which faces the upper side, and are transferred on the surface of the first lower transfer plate. This is to transfer the piles of coal transferred through the first dust shield 2070 after the piles of coal are uniformly dispersed and flattened on the surface of the first lower transfer plate 114 because the piles of coal are irregularly stacked on each other.

Next, the dropping coal decelerator 20 in which the left inclined plates 21 and the right inclined plates 22 are alternately installed at a specific angle and a specific interval is formed between the outlet 131 of the first coal dryer 110 and the inlet 160 of the second coal dryer 140.

In the dropping coal decelerator 20, when the piles of coal dried by the first coal dryer 110 are input to the second coal dryer 140, the piles of coal are decelerated while downwards moving along the plurality of left inclined plates 21 and the plurality of right inclined plates 22. In addition, generation of dust is suppressed while the piles of coal drop along the left inclined plates 21 and the right inclined plates 22. Further, because a lower end of the dropping coal decelerator 20 extends down to a location that is adjacent to the surface of the second transfer plate 144 of the second coal dryer 140, generation of dust is minimized while the piles of coal passing through the dropping coal decelerator 20 are input onto the surface of the second transfer plate 144 of the second coal dryer 140.

Further, the third flattener 50 horizontally divides, disperses and flattens a center of the piles C of the coal that drop from the dropping coal decelerator 20 onto the surfaces of the second transfer plates 144, which face the upper side, and are transferred on the surfaces of the second transfer plates 144. This is to transfer the piles of coal transferred from the dropping coal decelerator 20 after the piles of coal are uniformly dispersed and flattened on the surface of the second transfer plate 144 because the piles of coal are irregularly stacked on each other.

Further, a second dust shield 2080 has a shape of an approximately square column. Side plates 2082 on left and right sides of the second dust shield 2080 are integrally coupled to a rear plate 2081. The rear plate 2081 is inwards inclined as it goes from the upper side to the lower side. Circular arc-shaped first guide holes 2083a are formed through central portions of the side plates 2082 coupled to the rear plate 2081, and circular arc-shaped second guide holes 2083b are formed through lower portions of the side plates 2072. Further, a shock supporting step 2085 protrudes upwards from an upper end of the rear plate 2081. The shock supporting step 2085 supports a bottom surface of the second upper transfer plate 144 separated and dropping from the third guide rail 145. The shock supporting step 2085, which is in contact with the bottom surface of the second upper transfer plate 144, smoothly comes into contact with the bottom surfaces of the second transfer plates 144 at an approximately specific angle when a left portion of the second upper transfer plate 144 is inclined at a specific angle after being separated from the third guide rail 145.

Further, a shield compression plate 2086 is coupled to a front surface between the left and right side plates 2082 of the second dust shield 2080. That is, upper side surfaces of the shield compression plate 2086 are coupled by hinges. Further, first bosses 2087a protrude from opposite surfaces of a central portion of the shield compression plate 2086 and are inserted into the first guide holes 2083a, respectively, and second bosses 2087b protrude from opposite surfaces of a lower portion of the shield compression plate 2086 and are inserted into the second guide holes 2083b, respectively. In addition, the second bosses 2087b inserted into the second guide holes 2083b are elastically supported by elastic bodies 2084 at ends of the left and right side plates 2082, respectively. It is preferable that tension springs are applied to the elastic bodies 2084. The shield compression plate 2086 is inwards inclined as it goes from the upper side to the lower side, which is like the rear plate 2081. Thus, due to coupling between the shield compression plate 2086 and the rear plate 2081 to which the left and right side plates 2082 are integrally coupled, when the piles of coal are input from the upper side, the piles of coal are collected in the inner lower side, and are then dispersed and discharged onto the surface of the second lower transfer plate 144 at a fixed quantity. Here, the shield compression plate 2086 coupled to upper portions of the left and right side plates 2082 by hinges 2088 slightly decelerates discharge of coal by elastic force of the elastic bodies 2084 coupled to the second bosses 2087b. Further, it is preferable that the elastic force of the elastic bodies 2084 is determined based on a weight of the piles of coal. Opposite ends of the second dust shield 2080 are fixedly supported by a plurality of fixing members 2089 fixed to one side of the transfer device.

In addition, the second dust shield 2080 is installed between the first transfer plates 114 of the first coal dryer, that is, between the second upper transfer plate 144 and the second lower transfer plate 144 approximately in a vertical direction.

The fourth flattener 60 horizontally divides, disperses and flattens a center of the piles C of the coal that drop and input from the second dust shield 2080 to the surface of the second lower transfer plate, which faces the upper side, and are transferred on the surface of the first lower transfer plate. This is to transfer the piles of coal transferred through the second dust shield 2080 after the piles of coal are uniformly dispersed and flattened on the surface of the second lower transfer plate 144 because the piles of coal are irregularly stacked on each other.

Thus, in an apparatus for shielding dust according to transfer of dropping coal in the coal dryer according to the present invention, when the coal that is input by the fixed quantity coal supplier 400 at a fixed quantity is input onto and are transferred on the surface of the first upper transfer plate 114 of the first coal dryer 110 via the dust reducer 10, the first flattener 30 uniformly disperses and flattens the transferred piles of coal. Further, after the piles of coal are dried by the reheat steam while being transferred on the first upper transfer plate 114, the piles of coal loaded on the first transfer plates 114 drop onto the first dust shield 2070.

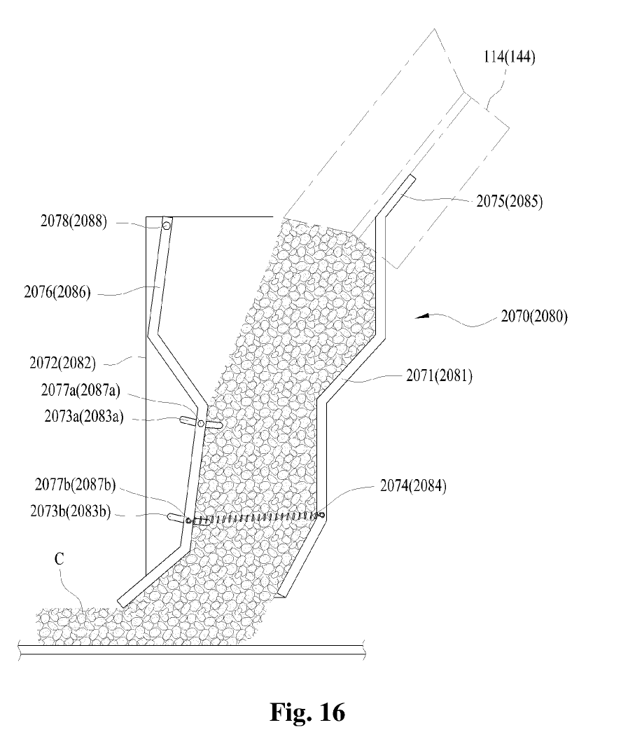

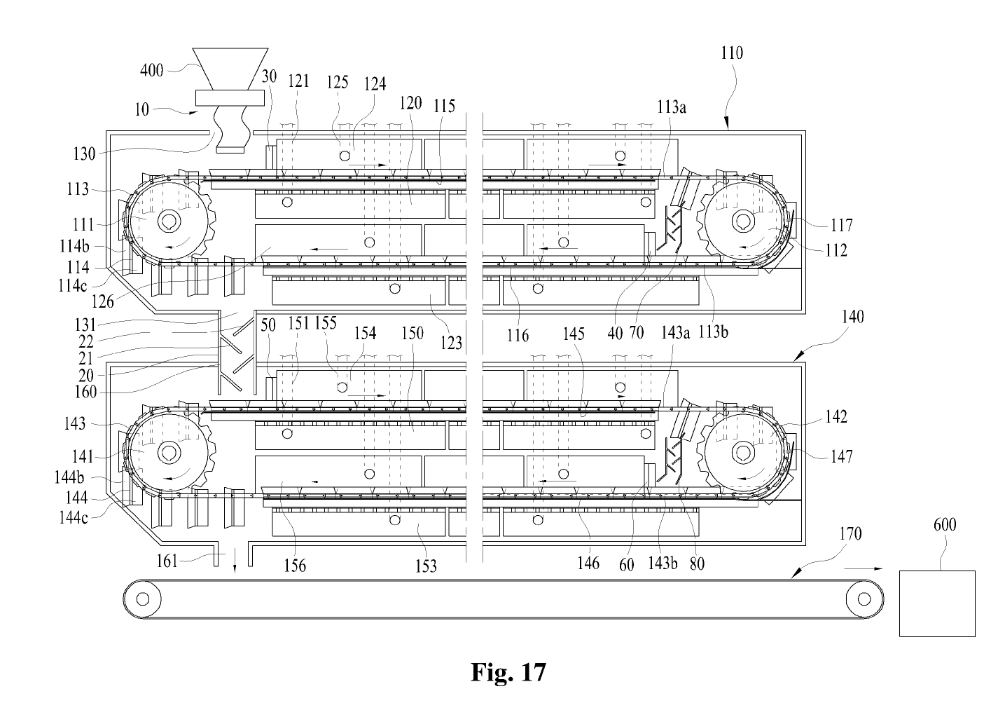

In FIGS. 16 and 17, while the piles C of coal are input to an input port 2070a of the first dust shield 2070, scattering of dust is minimized by the rear plate 2071 integrally coupled to the left and right side plates 2072 and the shield compression plate 2076. Further, the piles C of coal input to the input port 2070a of the first dust shield 2070 are focused while downwards moving to a focusing part 2070b. Further, while the piles C of coal downwards move to a dispersion discharge part 2070c at an inner lower portion of the first dust shield 2070, a descending speed of the piles C of coal is reduced by elastic force of the elastic bodies 2074 connected to the second bosses 2077b protruding through the second guide holes 2073b. That is, the elastic force of the elastic bodies 2074 is transferred to a lower portion of the shield compression plate 2076, and the piles C of coal receiving the elastic force are dispersed through an outlet of the dispersion discharge part 2070c, and are discharged onto the surface of the first lower transfer plate 114. In addition, the piles of coal discharged to the first lower transfer plate 114 are uniformly dispersed and flattened while passing through the second flattener 40. Further, the piles of coal loaded on the first lower transfer plate 114 are dried by the reheat steam while being transferred.

Further, after a dropping speed of the piles of coal completely dried by the first coal dryer 110 decreases while the piles of coal pass through the dropping coal decelerator 20 installed between the first coal dryer 110 and the second coal dryer 140, and generation of dust is suppressed as well, when the piles of coal are input onto and transferred on the surface of the second upper transfer plate 144 of the second coal dryer 140, the third flattener 50 uniformly disperses and flattens the transferred piles of coal. Further, after the piles of coal are dried by the reheat steam while being transferred on the second upper transfer plate 144, the piles of coal loaded on the second upper transfer plate 144 drop to an input port 2080a of the second dust shield 2080. While the piles C of coal are input to the input port 2080a of the second dust shield 2080, scattering of dust is minimized by the rear plate 2081 integrally coupled to the left and right side plates 2082 and the shield compression plate 2086. Further, the piles C of coal input to the input port 2080a of the second dust shield 2080 are focused while downwards moving to a focusing part 2080b. Further, while the piles C of coal downwards move to a dispersion discharge part 2080c at an inner lower portion of the second dust shield 2080, a descending speed of the piles C of coal is decreased by elastic force of the elastic bodies 2084 connected to the second bosses 2087b protruding through the second guide holes 2083b. That is, the elastic force of the elastic bodies 2084 is transferred to a lower portion of the shield compression plate 2086, and the piles C of coal receiving the elastic force are distributed through an outlet of the dispersion discharge part 2080c, and are discharged onto the surface of the second lower transfer plate 144. The piles of coal input onto the second lower transfer plate 144 are uniformly dispersed and flattened while passing through the fourth flattener 60. Further, the piles of coal loaded on the second lower transfer plate 144 are dried by the reheat steam while being transferred.

Next, a fourth embodiment of the apparatus for reducing dust according to supply of dropping coal in the coal dryer using reheat steam according to the present invention will be described in detail with reference to FIGS. 17 to 20.

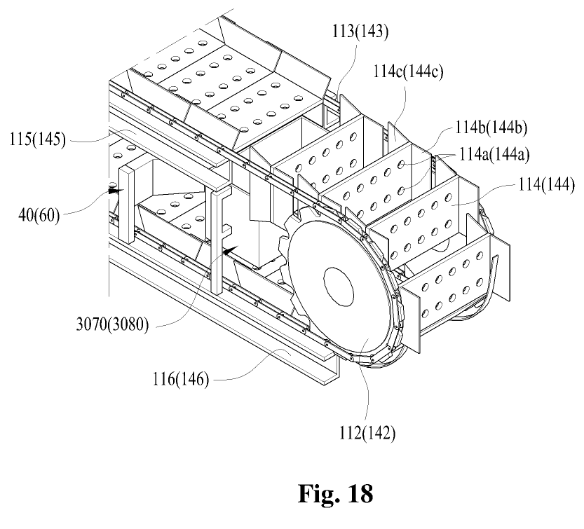

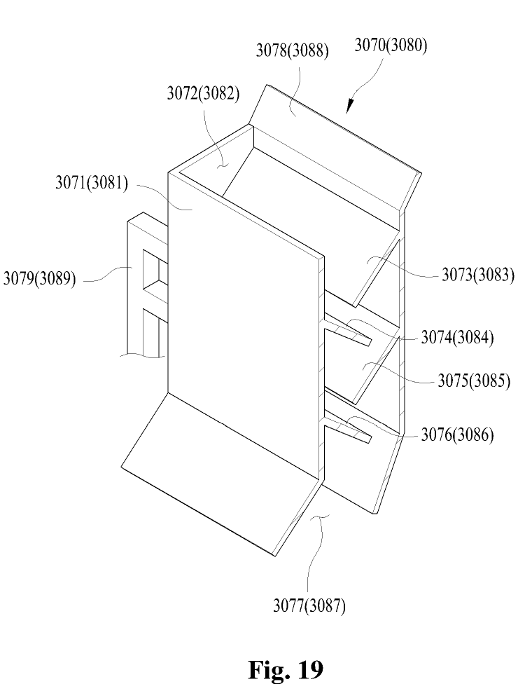

In FIGS. 18 and 19, a first deceleration and dust shield 3070 has a shape of an approximately vertically penetrated square column. The first deceleration and dust shield 3070 is configured such that a plurality of inclined plates are alternately installed inside a square column-shaped body 3071 on a left surface and a right surface of the body 3071 at a specific interval. That is, a first right inclined plate 3073, one end of which is coupled to an upper portion of a right surface of an interior of the body and which is inclined toward the left lower side at a specific angle, is installed. A left end of the first right inclined plate 3073 is installed to be spaced apart from a left surface of the body 3071 by a specific interval. Further, a first left inclined plate 3074, one end of which is coupled to an upper portion of a left surface of the interior of the body and which is inclined toward the right lower side at a specific angle, is installed below the first right inclined plate 3073. A right end of the first left inclined plate 3074 is installed to be spaced apart from the right surface of the body 3071 by a specific interval. Further, a second right inclined plate 3075, one end of which is coupled to the right surface of an interior of the body and which is inclined toward the left lower side at a specific angle, is installed below the first left inclined plate 3074. A left end of the second right inclined plate 3075 is installed to be spaced apart from the right surface of the body 3071 by a specific interval. Further, a second left inclined plate 3076, one end of which is coupled to the left surface of the interior of the body and which is inclined toward the right lower side at a specific angle, is installed below the second right inclined plate 3075. A right end of the second left inclined plate 3076 is installed to be spaced apart from the right surface of the body 3071 by a specific interval. Further, a discharge port 3077 inclined at a specific angle, that is, leftwards inclined at a specific angle, is formed below the body 3071. In addition, a shock supporting step 3078 supporting the bottom surface of the first upper transfer plate 114 separated and dropping from the first guide rail 115 protrudes upwards from a right upper end of an input port 3072 formed at an upper end of the body 3071. The shock supporting step 3078, which is in contact with the bottom surface of the first upper transfer plate 114, smoothly comes into contact with the bottom surfaces of the first transfer plates 114 at an approximately specific angle when a left portion of the first upper transfer plate 114 is inclined at a specific angle after being separated from the first guide rail 115.

Here, according to the first deceleration and dust shield 3070, after being downwards sliding from a surface of the first right inclined plate 3073, the piles of coals input to the input port 3072 drop to the surface of the first left inclined plate 3074. After dropping to the surface of the second right inclined plate 3075, the piles of coal drop to the surface of the second left inclined plate 3076 in turn and are discharged to the discharge port 3077. Thus, according to the first deceleration and dust shield 3070, while the piles of coal input from the upper side drop along the first right inclined plate 3073, the first left inclined plate 3074, the second right inclined plate 3075, and the second left inclined plate 3076 in a zigzag form, a speed of the piles of coal decreases and generation of dust is shielded inside the sealed body 3071 as well. Opposite ends of the first deceleration and dust shield 3070 are fixedly supported by the plurality of fixing members 3079 fixed to one side of the transfer device.

In addition, the first deceleration and dust shield 3070 is installed between the first transfer plates 114 of the first coal dryer, that is, between the first upper transfer plate 114 and the first lower transfer plate 114 approximately in a vertical direction.

The second flattener 40 horizontally divides, disperses and flattens a center of the piles C of the coal that drop and input from the first deceleration and dust shield 3070 to the surface of the first lower transfer plate, which faces the upper side, and are transferred on the surface of the first lower transfer plate. This is to transfer the piles of coal transferred through the discharge port 3077 of the first deceleration and dust shield 3077 after the piles of coal are uniformly dispersed and flattened on the surface of the first lower transfer plate 114 because the piles of coal are irregularly stacked on each other.

Next, the dropping coal decelerator 20 in which the left inclined plates 21 and the right inclined plates 22 are alternately installed at a specific angle and a specific interval is formed between the outlet 131 of the first coal dryer 110 and the inlet 160 of the second coal dryer 140. In the dropping coal decelerator 20, when the piles of coal dried by the first coal dryer 110 are input to the second coal dryer 140, the piles of coal are decelerated while downwards moving along the plurality of left inclined plates 21 and the plurality of right inclined plates 22. In addition, generation of dust is suppressed while the piles of coal drop along the left inclined plates 21 and the right inclined plates 22. Further, because a lower end of the dropping coal decelerator 20 extends down to a location that is adjacent to the surface of the second transfer plate 144 of the second coal dryer 140, generation of dust is minimized while the piles of coal passing through the dropping coal decelerator 20 are input onto the surface of the second transfer plate 144 of the second coal dryer 140.

Further, the third flattener 50 horizontally divides, disperses and flattens a center of the piles C of the coal that drop from the dropping coal decelerator 20 onto the surfaces of the second transfer plates 144, which face the upper side, and are transferred on the surfaces of the second transfer plates 144. This is to transfer the piles of coal transferred from the dropping coal decelerator 20 after the piles of coal are uniformly dispersed and flattened on the surface of the second transfer plate 144 because the piles of coal are irregularly stacked on each other.

Further, a second deceleration and dust shield 3080 has a shape of an approximately vertically penetrated square column, and the second deceleration and dust shield 3080 is configured such that a plurality of inclined plates are alternately installed inside a square column-shaped body 3081 on a left surface and a right surface of the body 3081 at a specific interval. That is, a first right inclined plate 3083, one end of which is coupled to an upper portion of a right surface of an interior of the body and which is inclined toward the left lower side at a specific angle, is installed. A left end of the first right inclined plate 3083 is installed to be spaced apart from a left surface of the body 3081 by a specific interval. Further, a first left inclined plate 3084, one end of which is coupled to an upper portion of a left surface of the interior of the body and which is inclined toward the right lower side at a specific angle, is installed below the first right inclined plate 3083. A right end of the first left inclined plate 3084 is installed to be spaced apart from the right surface of the body 3081 by a specific interval. Further, a second right inclined plate 3085, one end of which is coupled to the right surface of an interior of the body and which is inclined toward the left lower side at a specific angle, is installed below the first left inclined plate 3084. A left end of the second right inclined plate 3085 is installed to be spaced apart from the right surface of the body 3081 by a specific interval. Further, a second left inclined plate 3086, one end of which is coupled to the left surface of the interior of the body and which is inclined toward the right lower side at a specific angle, is installed below the second right inclined plate 3085. A right end of the second left inclined plate 3086 is installed to be spaced apart from the right surface of the body 3081 by a specific interval. Further, a discharge port 3087 inclined at a specific angle, that is, leftwards inclined at a specific angle, is formed below the body 3081. In addition, a shock supporting step 3088 supporting the bottom surface of the second upper transfer plate 144 separated and dropping from the third guide rail 145 protrudes upwards from a right upper end of an input port 3082 formed at an upper end of the body 3081. The shock supporting step 3088, which is in contact with the bottom surface of the second upper transfer plate 144, smoothly comes into contact with the bottom surfaces of the second transfer plates 144 at an approximately specific angle when a left portion of the second upper transfer plate 144 is inclined at a specific angle after being separated from the third guide rail 145.

Here, according to the second deceleration and dust shield 3080, after being downwards sliding from a surface of the first right inclined plate 3083, the piles of coals input to the input port 3082 drop to the surface of the first left inclined plate 3084. After dropping to the surface of the second right inclined plate 3085, the piles of coal drop to the surface of the second left inclined plate 3086 in turn and are discharged to the discharge port 3087. Thus, according to the second deceleration and dust shield 3080, while the piles of coal input from the upper side drop along the first right inclined plate 3083, the first left inclined plate 3084, the second right inclined plate 3085, and the second left inclined plate 3086 in a zigzag form, a speed of the piles of coal decreases and generation of dust is shielded inside the sealed body 3081 as well. Opposite ends of the second deceleration and dust shield 3080 are fixedly supported by the plurality of fixing members 3089 fixed to one side of the transfer device.

In addition, the second deceleration and dust shield 3080 is installed between the second transfer plates 144 of the first coal dryer, that is, between the second upper transfer plate 144 and the second lower transfer plate 144 approximately in a vertical direction.

The fourth flattener 60 horizontally divides, disperses and flattens a center of the piles C of the coal that drop and input from the second deceleration and dust shield 3080 to the surface of the first lower transfer plate, which faces the upper side, and are transferred on the surface of the first lower transfer plate. This is to transfer the piles of coal transferred through the discharge port 3077 of the second deceleration and dust shield 3077 after the piles of coal are uniformly dispersed and flattened on the surface of the second lower transfer plate 144 because the piles of coal are irregularly stacked on each other.

Thus, in a deceleration and dust shielding apparatus according to transfer of dropping coal in the coal dryer according to the present invention, when the coal that is input by the fixed quantity coal supplier 400 at a fixed quantity is input onto and are transferred on the surface of the first upper transfer plate 114 of the first coal dryer 110 via the dust reducer 10, the first flattener 30 uniformly disperses and flattens the transferred piles of coal. Further, after the piles of coal are dried by the reheat steam while being transferred on the first upper transfer plate 114, the piles of coal loaded on the first transfer plates 114 drop onto the first deceleration and dust shield 3070.

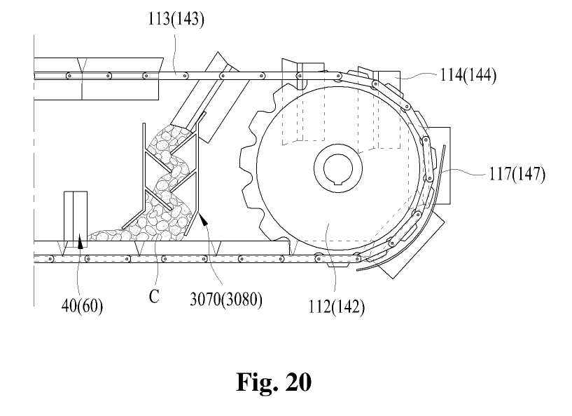

In FIG. 20, a speed of the piles C of coal input to the input port 3072 at an upper portion of the body 3071 of the first deceleration and dust shield 3070 decreases while the piles C of coal drops sequentially via the first right inclined plate 3073, the first left inclined plate 3074, the second right inclined plate 3075 and the second left inclined plate 3076 that are installed inside the body 3071 from an upper portion to a lower portion of the body 3071 at a specific interval to be inclined. Further, while the piles C of coal is decelerated by the plurality of inclined plates 3073 to 3076 inside the body 3071, scattering of dust is shielded. Here, a transfer speed of the piles C of coal is determined based on inclined angles of the inclined plates 3073 to 3076. Further, the piles C of coal transferred via the inclined plates 3073 to 3076 are dispersed and discharged onto the surface of the first lower transfer plate 114 through the discharge port 3077 formed below the body 3071 to be inclined at a specific angle.

In addition, the piles of coal discharged to the first lower transfer plate 114 are uniformly dispersed and flattened while passing through the second flattener 40. Further, the piles of coal loaded on the first lower transfer plate 114 are dried by the reheat steam while being transferred.

Further, after a dropping speed of the piles of coal completely dried by the first coal dryer 110 decreases while the piles of coal pass through the dropping coal decelerator 20 installed between the first coal dryer 110 and the second coal dryer 140, and generation of dust is suppressed as well, when the piles of coal are input onto and transferred on the surface of the second upper transfer plate 144 of the second coal dryer 140, the third flattener 50 uniformly disperses and flattens the transferred piles of coal. Further, after the piles of coal are dried by the reheat steam while being transferred on the second upper transfer plate 144, the piles of coal loaded on the second upper transfer plate 144 drop to the input port 3082 at an upper portion of the body 3081 of the second deceleration and dust shield 3080. A speed of the piles C of coal input to the input port 3082 of the second deceleration and dust shield 3080 decreases while the piles C of coal drops sequentially via the first right inclined plate 3083, the first left inclined plate 3084, the second right inclined plate 3085 and the second left inclined plate 3086 that are installed inside the body 3081 from an upper portion to a lower portion of the body 3081 at a specific interval to be inclined. Further, while the piles C of coal is decelerated by the plurality of inclined plates 3083 to 3086 inside the body 3081, scattering of dust is shielded. Here, a transfer speed of the piles C of coal is determined based on inclined angles of the inclined plates 3083 to 3086. Further, the piles C of coal transferred via the inclined plates 3083 to 3086 are dispersed and discharged onto the surface of the third lower transfer plate 144 through the discharge port 3087 formed below the body 3081 to be inclined at a specific angle.

In addition, the piles of coal discharged to the first lower transfer plate 144 are uniformly dispersed and flattened while passing through the fourth flattener 60. Further, the piles of coal loaded on the second lower transfer plate 144 are dried by the reheat steam while being transferred.

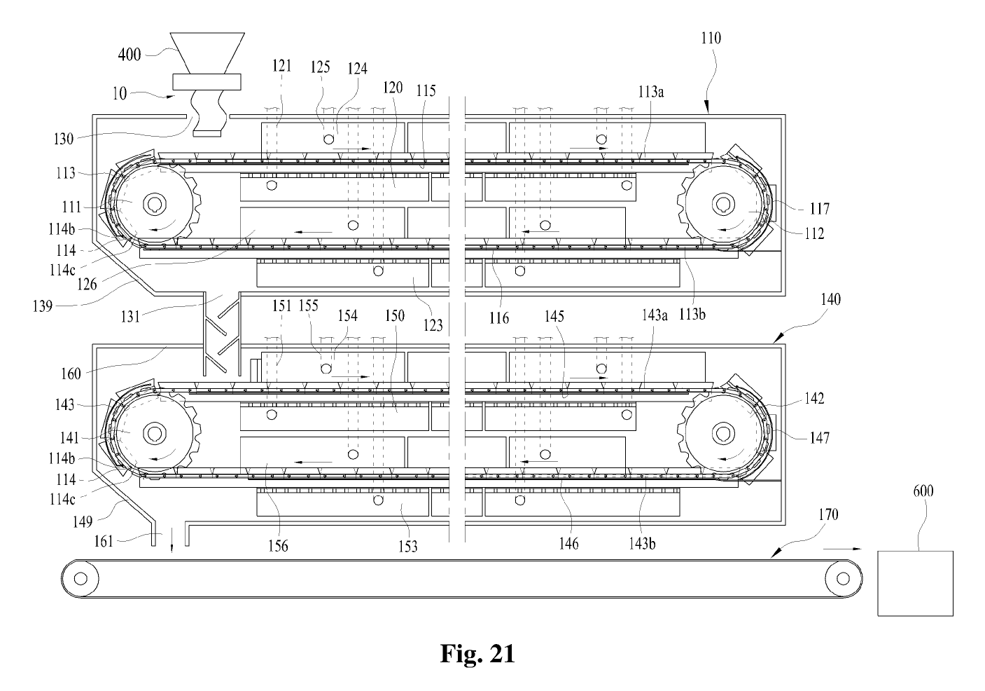

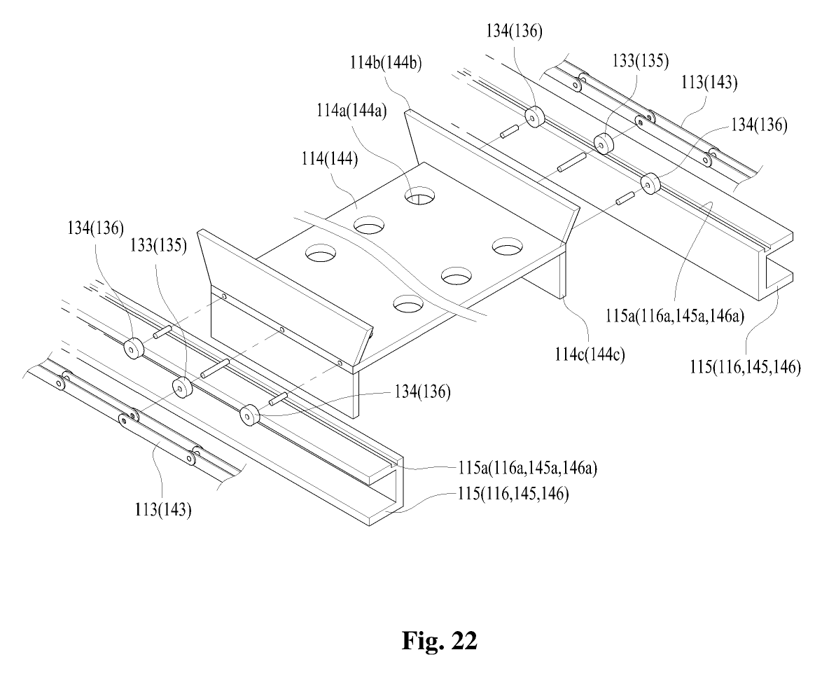

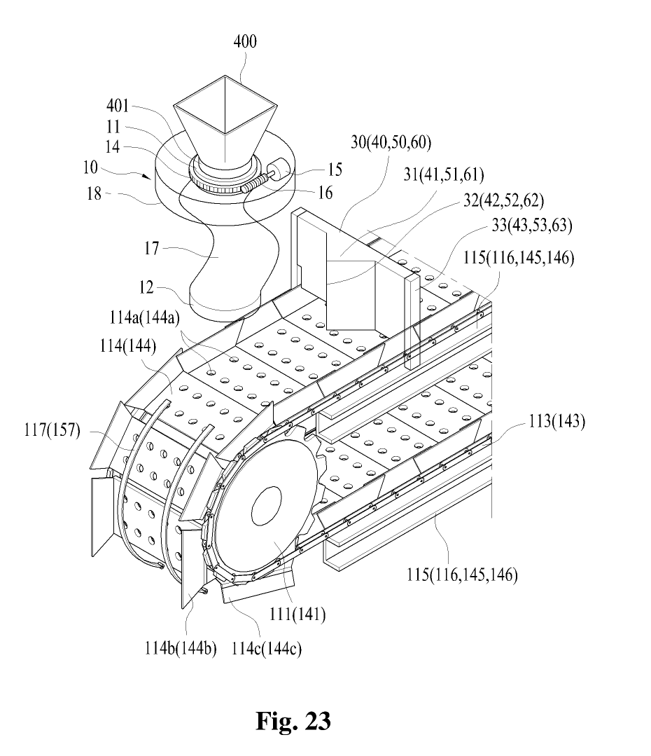

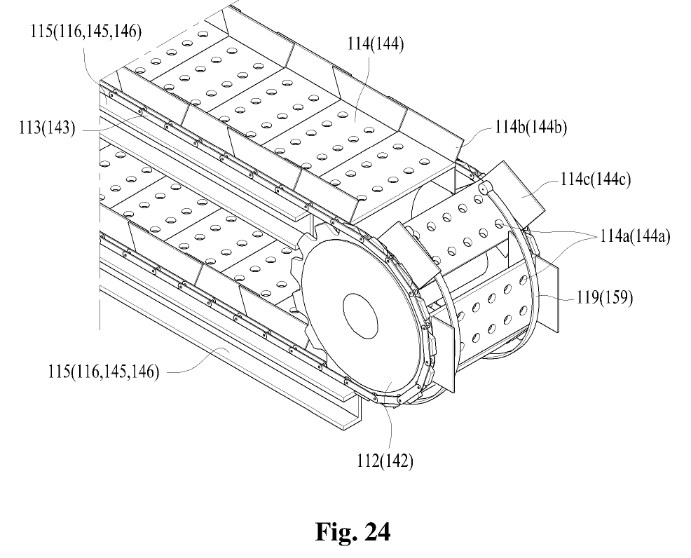

Meanwhile, a fifth embodiment of the apparatus for reducing dust according to supply of dropping coal in the coal dryer using reheat steam according to the present invention will be described in detail with reference to FIGS. 21 to 26. The fifth embodiment includes a configuration and a structure for dropping and supplying piles of coals, which are transferred on transfer plates in a multi-stage dryer, onto transfer plates of a lower dryer in addition to a configuration and a structure of the transfer plates. Further, the fifth embodiment includes configurations of the first flattener to the fourth flattener and a configuration of the dropping coal decelerator between the first coal dryer and the second coal dryer.

First, in FIGS. 21 to 24, the coal dryer 100 includes a multiple stage dryer configured to dry coal input from the fixed quantity coal supplier 400, that is, the first coal dryer 110, the second coal dryer 140 configured to secondarily dry the coal dried by the first coal dryer, and the third coal dryer 170 configured to supply the coal dried by the second coal dryer to the dry coal storage tank 600 after the coal is naturally dried.

The first coal dryer 110 includes a pair of first driving sprockets 111 and a pair of first driven sprockets 112 fastened to each other by first chains 113 to be spaced apart from each other by a specific distance, a plurality of first transfer plates 114 that are hinge-coupled to each other between the first chains 113, a pair of first guide rails 115 installed below an second upper chain 113a connected between the first driving sprockets 111 and the first driven sprockets 112 to horizontally support the first upper transfer plates 114, a pair of second guide rails 116 installed below a first lower chain 113b connected between the first driving sprockets 111 and the first driven sprockets 112 to horizontally support the first lower transfer plates 114, a first steam chamber 120 installed below the first upper chain 113a to spray reheat steam supplied by a reheater 500, a second steam chamber 123 installed below the first lower chain 113b to spray the reheat steam supplied by the reheater 500, a first flue gas chamber 124 installed above the first upper chain 113a to collect flue gas, and a second flue gas chamber 126 installed above the first lower chain 113 to collect flue gas.

Further, first transfer rollers 133 are hinge-coupled between centers of opposite sides of the first transfer plates 114 and the first chains 113, respectively. That is, the first transfer rollers 133 are hinge-coupled between centers of side surfaces of the first transfer plates 114 and the first chains 113. Further, first auxiliary rollers 134 are hinge-coupled to the side surfaces of the second transfer plates 114 on left and right sides of the first transfer rollers 114. The first auxiliary rollers 134 are hinge-coupled to the side surfaces of the first transfer plates 114, that is, to the left and right sides of the first transfer plates 114.

In addition, grooves 115a and grooves 116a configured to guide rotation of the first transfer rollers 133 and the first auxiliary rollers 134 are formed on surfaces of the first guide rails 115 and the second guide rails 116, respectively. Thus, the first transfer plates 114 are transferred along the grooves 115a formed on the surfaces of the first guide rails 115 and the grooves 116a formed on the surfaces of the second guide rails 116 by the first transfer rollers 133 and the first auxiliary rollers 134 which are hinge-coupled to the first transfer plates 114.

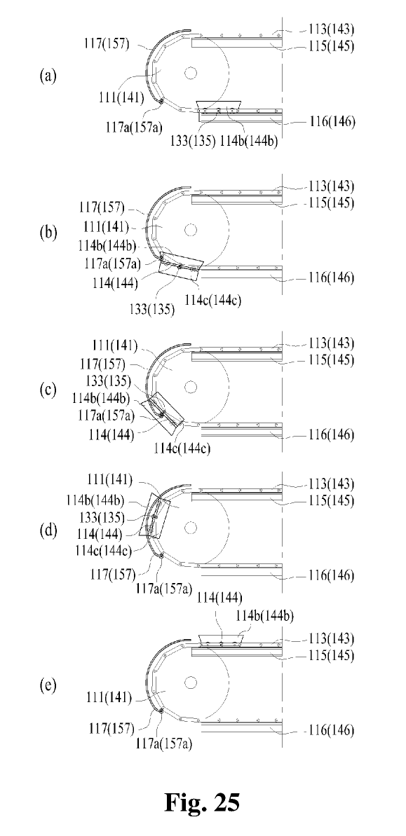

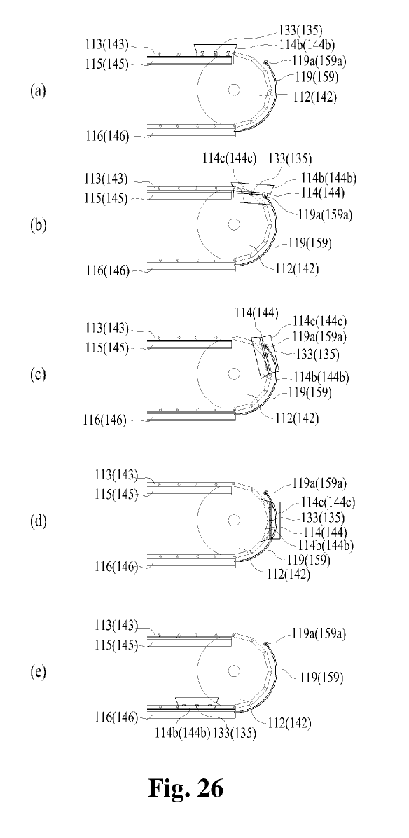

Meanwhile, in FIGS. 25A to 25E and FIGS. 26A to 26E, first guide bars 117 configured to unidirectionally rotate and upwards support the first lower transfer plates 114 separated from the second guide rails 116 are installed from an upper side via a side surface to a lower side of the first driving sprockets 111. First triggers 117a are coupled to ends of the first guide bars 117, respectively, and the first triggers 117a are axially rotating rollers. The first triggers 117a are installed at locations that are in contact with sides of bottom surfaces of the first upper transfer plates 114.

Further, second guide bars 119 configured to unidirectionally rotate and downwards support the first upper transfer plates 114 separated from the first guide rails 115 are installed from a lower side via a side surface to an upper side of the first driven sprockets 112. Second triggers 119a are coupled to ends of the second guide bars 119, respectively, and the second triggers 119a are axially rotating rollers. The second triggers 119a are installed at locations that are in contact with sides of flat surfaces of the first lower transfer plates 114.

Further, the second coal dryer 140 includes a pair of second driving sprockets 141 and a pair of second driven sprockets 142 that are fastened to each other by second chains 143 to be spaced apart from each other by a specific interval, a plurality of second transfer plates 144 that are hinge-coupled between the second chains 143, a pair of third guide rails 145 that are installed below a second upper chain 143a connected between the second driving sprockets 141 and the second driven sprockets 142 to horizontally support the second upper transfer plates 144, a pair of fourth guide rails 146 that are installed below a second lower chain 143b connected between the second driving sprockets 141 and the second driven sprockets 142 to horizontally support the second lower transfer plates 144, a third steam chamber 150 that is installed below the second upper chain 143a to spray reheat steam supplied by the reheater 500, a fourth steam chamber 153 that is installed below the second lower chain 143b to spray the reheat steam supplied by the reheater 500, a third flue gas chamber 154 that is installed above the second upper chain 143a to collect flue gas, and a fourth flue gas chamber 156 that is installed above the second lower chain 143b to collect flue gas.

Further, second transfer rollers 135 are hinge-coupled between centers of opposite sides of the second transfer plates 144 and the second chains 113. That is, the second transfer rollers 135 are hinge-coupled between centers of the side surfaces of the second transfer plates 144 and the second chains 143. Further, second auxiliary rollers 136 are hinge-coupled to the side surfaces of the second transfer plates 114 on left and right sides of the second transfer rollers 144. The second auxiliary rollers 136 are hinge-coupled to side surfaces of the second transfer plates 114, that is, left and right sides of the second transfer plates 144.

In addition, grooves 145a and grooves 146a configured to guide rotation of the second transfer rollers 135 and the second auxiliary rollers 136 are formed on surfaces of the third guide rails 145 and the fourth guide rails 146, respectively. Thus, the second transfer plates 144 are transferred along the grooves 145a formed on the surfaces of the third guide rails 145 and the grooves 146a formed on the surfaces of the fourth guide rails 146, by the second transfer rollers 135 and the second auxiliary rollers 136 which are hinge-coupled to the second transfer plates 144.

Meanwhile, in FIGS. 25A to 25E and FIGS. 26A to 26E, third guide bars 157 configured to unidirectionally rotate and upwards support the second lower transfer plates 144 separated from the fourth guide rails 146 are installed from an upper side via a side surface to a lower side of the second driving sprockets 141. Third triggers 157a are coupled to ends of the third guide bars 157, respectively, and the third triggers 157a are axially rotating rollers. The third triggers 157a are installed at locations that are in contact with sides of bottom surfaces of the second upper transfer plates 144.

Further, fourth guide bars 159 configured to unidirectionally rotate and downwards support the second upper transfer plates 144 separated from the third guide rails 145 are installed from a lower side via a side surface to an upper side of the second driven sprockets 142. Fourth triggers 159a are coupled to ends of the fourth guide bars 159, respectively, and the fourth triggers 159a are axially rotating rollers. The fourth triggers 159a are installed at locations that are in contact with sides of flat surfaces of the second lower transfer plates 144.

Further, a plurality of through-holes 114a are formed in the first transfer plates 114 such that the reheat steam sprayed in the first steam chamber 120 and the second steam chamber 123 comes into contact with coal particles by passing through the first transfer plates 114. Guards 114b having a specific height are installed at left and right sides of top surfaces of the first transfer plates 114 such that piles of the input coal do not flow down to left sides or right sides of the first transfer plate 114. The guards 114b have an approximately trapezoidal shape, an upper portion of which is wide and a lower portion of which is narrow. Thus, upper portions of the guards 114b of the first transfer plates 114, which are adjacent to each other, overlap each other. Here, it is preferable that the guards 114b of the first transfer plates 114, which are adjacent to each other, are installed in an approximately zigzag direction. Further, shielding plates 114c are installed at left and right sides of bottom surfaces of the first transfer plates 114 such that the reheat steam sprayed in the first steam chamber 120 and the second steam chamber 123 is not dissipated due to spraying thereof to left and right sides of the first steam chamber 120 and the second steam chamber 123, respectively.

Further, a plurality of through-holes 144a are formed in the second transfer plates 144 such that reheat steam sprayed in the third steam chamber 150 and the fourth steam chamber 153 comes into contact with coal particles by passing through the second transfer plates 144. Guards 144b having a specific height are installed at left and right sides of top surfaces of the second transfer plates 144 such that the piles of the input coal do not flow down to left sides or right sides of the second transfer plates 144. The guards 144b have an approximately trapezoidal shape, an upper portion of which is wide and a lower portion of which is narrow. Thus, upper portions of the guards 144b of the second transfer plates 144, which are adjacent to each other, overlap each other. Here, it is preferable that the guards 144b of the second transfer plates 144, which are adjacent to each other, are installed in an approximately zigzag direction. Further, shielding plates 144c are installed at left and right sides of bottom surfaces of the second transfer plates 144 such that the reheat steam sprayed in the third steam chamber 150 and the fourth steam chamber 153 is not dissipated due to spraying thereof to left and right sides of the third steam chamber 150 and the fourth steam chamber 153, respectively.

Thus, in an apparatus for transferring coal in the coal dryer according to the present invention, coal input by the fixed quantity coal supplier 400 at a fixed quantity is input onto and is transferred on the surface of the first upper transfer plate 144 of the first coal dryer 110. Further, the piles of coal loaded on the first upper transfer plates 114 are dried by the reheat steam while being transferred.

Further, in FIG. 26A, the first upper transfer plates 114 are transferred to ends of the first guide rails 115 through rotation of the first driven sprockets 112. In FIG. 26B, as left bottom surfaces of the first upper transfer plates 114 are separated from the ends of the first guide rails 115, right bottom surfaces of the first upper transfer plates 114 comes into contact with the second triggers 119a of the second guide bars 119. Here, the first upper transfer plates 114 hinge-coupled to the first upper chains 113 through the first transfer rollers 133 are separated from the first guide rails 115 and, at the same time, are rotated about the first transfer rollers 133 in a left direction, to drop the loaded piles of coal. Further, in FIG. 26C, the bottom surfaces of the first upper transfer plates 114 are moved downward along the second triggers 119a. In FIG. 26D, the first upper transfer plates 114 are moved along a radius of rotation of the first driven sprockets 112 without rotation in a state in which the bottom surfaces thereof are in contact with the second guide bars 119 while maintaining an approximately upright state. In FIG. 26E, while being moved on the second guide rails 116, the first upper transfer plates 114 moved to the lower side load and transfer the piles of coal dropped from first following transfer plates to the first lower transfer plates 114. Further, the piles of coal loaded on the first lower transfer plates 114 are dried by the reheat steam while being transferred.

Next, in FIG. 25A, the first lower transfer plates 114 are transferred to ends of the second guide rails 116 through rotation of the first driving sprockets 111. In FIG. 25B, as right bottom surfaces of the first upper transfer plates 114 are separated from the ends of the second guide rails 116, left flat surfaces of the first lower transfer plates 114 come into contact with the first triggers 117a of the first guide bars 117. Here, the first lower transfer plates 114 hinge-coupled to the first lower chains 113 through the first transfer rollers 133 are separated from the second guide rails 116 and, at the same time, are rotated about the first transfer rollers 133 in a left direction, to drop the loaded piles of coal. Further, in FIG. 25C, the flat surfaces of the first upper transfer plates 114 are moved upward along the first triggers 117a. In FIG. 25D, the first lower transfer plates 114 are moved along a radius of rotation of the first driving sprockets 111 without rotation in a state in which the flat surfaces thereof are in contact with the first guide bars 117 while maintaining an approximately upright state. In FIG. 25E, the first lower transfer plates 114 moved to the upper side are changed to the first upper transfer plates 114 while being moved on the first guide rails 115, to load and transfer the piles of coal input by the fixed quantity coal supplier 400 at a fixed quantity. Further, the piles of coal loaded on the first upper transfer plates 114 are dried by the reheat steam while being transferred. The piles of coal dropping onto the first lower transfer plates 114 are discharged to the outlet 131 along a first slope 139.

Further, the piles of coal dropping from the first coal dryer 110 to the outlet 131 are input to the inlet 160 of the second coal dryer 140 and are input onto and moved on the surfaces of the second upper transfer plates 144 of the second coal dryer 140 Further, the piles of coal loaded on the second upper transfer plates 144 are dried by the reheat steam while being transferred.

A process of transferring coal in the second coal dryer 140 is the same as the transfer process of the first coal dryer 140, which illustrated in FIGS. 25 and 26. Thus, the piles of coal dropping onto the second lower transfer plates 144 are discharged to the outlet 161 along a second slope 149. Further, the piles of coal dropping from the second coal dryer 140 to the outlet 161 are naturally dried while being supplied and transferred to the third coal dryer 170.

Thus, the plurality of transfer plates configured to transfer the piles of coal are transferred along the guide rails by the transfer rollers and the auxiliary rollers that are hinge-coupled, so that generation of noise may be minimized. Further, the transfer plates may be easily rotated, supported and transferred by the guide bars and the triggers installed on sides of the driving sprockets and the driven sprockets, and the coal dryer may be miniaturized, so that generation of dust may be suppressed.

In this way, the apparatus for reducing dust according to supply of dropping coal in the coal dryer using reheat steam according to the present invention, which may suppress generation of dust from the coal dropping and input from an upper portion of the coal dryer and may effectively dry the coal by removing moisture contained in the coal by high-temperature reheat steam sprayed through a plurality of through-holes penetrated in the transfer plates while the piles of coal are transferred on the plurality of transfer plates, has an advantage in that generation of dust from the dropped and input piles of coal may be minimized, and the piles of coal are uniformly dispersed and flattened so that the high-temperature reheat steam may easily come into contact with coal particles.

While the present invention has been described with respect to the specific embodiments, it will be apparent to those skilled in the art that various changes and modifications may be made without departing from the spirit and scope of the invention as defined in the following claims.

### INDUSTRIAL AVAILABILITY

The present invention has an industrial availability in that in a coal dryer using reheat steam, piles of coal dropped and input to a multiple stage coal dryer are supplied and transferred while generation of dust from the piles of coal is minimized, and moisture remaining inside and outside the coal that is use fuel of a thermal power plant is removed, so that incomplete combustion of the coal may be prevented, a caloric value of the coal may increase, discharge of pollutants may be minimized, a spontaneous combustion rate may be reduced due to a reduction in the moisture of the coal, and stability of coal supply may be improved by increasing utilization of low grade coal having low demands.

1. An apparatus for reducing dust according to supply of dropping coal in a coal dryer using reheat steam, the coal dryer comprising:
a first coal dryer comprising a pair of first driving sprockets and a pair of first driven sprockets fastened to each other by first chains to be spaced apart from each other by a specific distance, a plurality of first transfer plates hinge-coupled between the first chains, a pair of first guide rails installed below a first upper chain connected between the first driving sprockets and the first driven sprockets to horizontally support first upper transfer plates, a pair of second guide rails installed below a first lower chain connected between the first driving sprockets and the first driven sprockets to horizontally support first lower transfer plates, a first steam chamber installed below the first upper chain to spray reheat steam supplied by a reheater, a second steam chamber installed below the first lower chain to spray the reheat steam supplied by the reheater, a first flue gas chamber installed above the first upper chain to collect flue gas, and a second flue gas chamber installed above the first lower chain to collect flue gas; and
a second coal dryer comprising a pair of second driving sprockets and a pair of second driven sprockets fastened to each other by second chains to be spaced apart from each other by a specific distance, a plurality of second transfer plates hinge-coupled between the second chains, a pair of third guide rails installed below a second upper chain connected between the second driving sprockets and the second driven sprockets to horizontally support second upper transfer plates, a pair of fourth guide rails installed below a second lower chain connected between the second driving sprockets and the second driven sprockets to horizontally support second lower transfer plates, a third steam chamber installed below the second upper chain to spray the reheat steam supplied by the reheater, a fourth steam chamber installed below the second lower chain to spray the reheat steam supplied by the reheater, a third flue gas chamber installed above the second upper chain to collect flue gas, and a fourth flue gas chamber installed above the lower chain to collect flue gas,
wherein coal primarily dried by the first coal dryer is input to the second coal dryer to be secondarily dried,
the coal dryer further comprising:
a fixed quantity coal supplier configured to supply a specific amount of coal to surfaces of the first transfer plates, which face the upper side; and
a dust reducer comprising an inlet tube coupled to an outlet of the fixed quantity coal supplier by a bearing, a worm wheel coupled to an outer peripheral surface of the inlet tube, a worm gear-coupled to the worm wheel and rotated by rotational force transferred from a motor, a curbed tube, an upper end of which is coupled to the inlet tube, and an outlet tube coupled to an end of the curved tube, and
the apparatus comprising:
a first flattener configured to uniformly disperse and flatten piles of coal dropped and input from the dust reducer to surfaces of the first upper transfer plates, which face the upper side, and transferred on the surfaces of the first upper transfers plates;
a first coal receiver having a plurality of panels fixedly installed between the pair of first driven sprockets radially with respect to a rotary shaft at a specific angle;
a second flattener configured to uniformly disperse and flatten the piles of coal dropped and input from the first coal receiver to surfaces of the first lower transfer plates, which face the upper side, through rotation of the first driven sprockets, and transferred on the surfaces of the first lower transfer plates;
a third flattener configured to uniformly disperse and flatten the piles of coal dropped and input from the first coal dryer to surfaces of the second upper transfer plates, which face the upper side, of the second coal dryer, and transferred on the surfaces of the second upper transfer plates;
a second coal receiver having a plurality of panels installed between the pair of second driven sprockets radially with respect to a rotary shaft at a specific angle; and
a fourth flattener configured to uniformly disperse and flatten the piles of coal dropped and input from the second coal receiver to surfaces of the second lower transfer plates, which face the upper side, through rotation of the second driving sprockets,
wherein the first coal receiver receives the piles of coal dropped from the surfaces of the first upper transfer plates, is rotated according to the rotation of the first driven sprockets, and then inputs the piles of coal to the surfaces of the first lower transfer plates so as to suppress dust, and the second coal receiver receives the piles of coal dropped from the surfaces of the second upper transfer plates, is rotated according to rotation of the second driven sprockets, and then inputs the piles of coal to the surfaces of the second lower transfer plates so as to suppress dust.

2. The apparatus of claim 1, wherein installation angles of the panels of the first coal receiver are determined such that the piles of coal are dropped and input to a space between the panels after left ends of the first upper transfer plates are separated from the first guide rails, and installation angles of the panels of the second coal receiver are determined such that the piles of coal are dropped and input to a space between the panels after left ends of the second upper transfer plates are separated from the third guide rails.

3. An apparatus for reducing dust according to supply of dropping coal in a coal dryer using reheat steam, the coal dryer comprising:
a first coal dryer comprising a pair of first driving sprockets and a pair of first driven sprockets fastened to each other by first chains to be spaced apart from each other by a specific distance, a plurality of first transfer plates hinge-coupled between the first chains, a pair of first guide rails installed below a first upper chain connected between the first driving sprockets and the first driven sprockets to horizontally support first upper transfer plates, a pair of second guide rails installed below a first lower chain connected between the first driving sprockets and the first driven sprockets to horizontally support first lower transfer plates, a first steam chamber installed below the first upper chain to spray reheat steam supplied by a reheater, a second steam chamber installed below the first lower chain to spray the reheat steam supplied by the reheater, a first flue gas chamber installed above the first upper chain to collect flue gas, and a second flue gas chamber installed above the first lower chain to collect flue gas; and
a second coal dryer comprising a pair of second driving sprockets and a pair of second driven sprockets fastened to each other by second chains to be spaced apart from each other by a specific distance, a plurality of second transfer plates hinge-coupled between the second chains, a pair of third guide rails installed below a second upper chain connected between the second driving sprockets and the second driven sprockets to horizontally support second upper transfer plates, a pair of fourth guide rails installed below a second lower chain connected between the second driving sprockets and the second driven sprockets to horizontally support second lower transfer plates, a third steam chamber installed below the second upper chain to spray the reheat steam supplied by the reheater, a fourth steam chamber installed below the second lower chain to spray the reheat steam supplied by the reheater, a third flue gas chamber installed above the second upper chain to collect flue gas, and a fourth flue gas chamber installed above the lower chain to collect flue gas,
wherein coal primarily dried by the first coal dryer is input to the second coal dryer to be secondarily dried,
the coal dryer further comprising:
a fixed quantity coal supplier configured to supply a specific amount of coal to surfaces of the first transfer plates, which face the upper side; and
a dust reducer comprising an inlet tube coupled to an outlet of the fixed quantity coal supplier by a bearing, a worm wheel coupled to an outer peripheral surface of the inlet tube, a worm gear-coupled to the worm wheel and rotated by rotational force transferred from a motor, a curbed tube, an upper end of which is coupled to the inlet tube, and an outlet tube coupled to an end of the curved tube, and
the apparatus comprising:
a first flattener configured to uniformly disperse and flatten piles of coal dropped and input from the dust reducer to surfaces of the first upper transfer plates, which face the upper side, and transferred on the surfaces of the first upper transfers plates;
a first dust reducer having side plates formed on opposite surfaces of the first dust reducer to have a shape of a flat plate, having a convexo-concave part formed on a surface between upper surfaces of the side plates to have a specific vertical interval, having a shock supporting step protruding upwards from an upper end of the first dust reducer to support bottom surfaces of the first upper transfer plates separated and dropped from the first guide rails, and installed between the first upper transfer plates and the first lower transfer plates to be inclined at a specific angle;
a second flattener configured to uniformly disperse and flatten the piles of coal transferred to surfaces of the first lower transfer plates along a surface of the first dust reducer;
a third flattener configured to uniformly disperse and flatten the piles of coal dropped and input from the first coal dryer to surfaces of the second upper transfer plates of the second coal dryer, which face the upper side, and transferred on the surfaces of the second upper transfer plates of the second coal dryer;
a second dust reducer having side plates formed on opposite surfaces of the first dust reducer to have a shape of a flat plate, having a convexo-concave part formed on a surface between upper surfaces of the side plates to have a specific vertical interval, having a shock supporting step protruding upwards from an upper end of the second dust reducer to support bottom surfaces of the second upper transfer plates separated and dropped from the third guide rails, and installed between the first upper transfer plates and the first lower transfer plates to be inclined at a specific angle; and
a fourth flattener configured to uniformly disperse and flatten the piles of coal transferred to surfaces of the second lower transfer plates along a surface of the second dust reducer,
wherein the first dust reducer receives the piles of coal dropped from the surfaces of the first upper transfer plates to input the piles of coal to the surfaces of the first lower transfer plates in a sliding manner so as to suppress dust, and the second dust reducer receives the piles of coal dropped from the surfaces of the second upper transfer plates to input the piles of coal to the surfaces of the second lower transfer plates in a sliding manner so as to suppress dust.

4. The apparatus of claim 1, wherein each of the first flattener to the fourth flattener comprises a column-shaped body, a dispersion boss protruding from a central portion of a front surface of the body, and a pair of fixing members configured to fixedly support opposite ends of the body.

5. An apparatus for reducing dust according to supply of dropping coal in a coal dryer using reheat steam, the coal dryer comprising:
a first coal dryer comprising a pair of first driving sprockets and a pair of first driven sprockets fastened to each other by first chains to be spaced apart from each other by a specific distance, a plurality of first transfer plates hinge-coupled between the first chains, a pair of first guide rails installed below a first upper chain connected between the first driving sprockets and the first driven sprockets to horizontally support first upper transfer plates, a pair of second guide rails installed below a first lower chain connected between the first driving sprockets and the first driven sprockets to horizontally support first lower transfer plates, a first steam chamber installed below the first upper chain to spray reheat steam supplied by a reheater, a second steam chamber installed below the first lower chain to spray the reheat steam supplied by the reheater, a first flue gas chamber installed above the first upper chain to collect flue gas, and a second flue gas chamber installed above the first lower chain to collect flue gas; and
a second coal dryer comprising a pair of second driving sprockets and a pair of second driven sprockets fastened to each other by second chains to be spaced apart from each other by a specific distance, a plurality of second transfer plates hinge-coupled between the second chains, a pair of third guide rails installed below a second upper chain connected between the second driving sprockets and the second driven sprockets to horizontally support second upper transfer plates, a pair of fourth guide rails installed below a second lower chain connected between the second driving sprockets and the second driven sprockets to horizontally support second lower transfer plates, a third steam chamber installed below the second upper chain to spray the reheat steam supplied by the reheater, a fourth steam chamber installed below the second lower chain to spray the reheat steam supplied by the reheater, a third flue gas chamber installed above the second upper chain to collect flue gas, and a fourth flue gas chamber installed above the lower chain to collect flue gas,
wherein coal primarily dried by the first coal dryer is input to the second coal dryer to be secondarily dried,
the coal dryer further comprising:
a fixed quantity coal supplier configured to supply a specific amount of coal to surfaces of the first transfer plates, which face the upper side; and
a dust reducer comprising an inlet tube coupled to an outlet of the fixed quantity coal supplier by a bearing, a worm wheel coupled to an outer peripheral surface of the inlet tube, a worm gear-coupled to the worm wheel and rotated by rotational force transferred from a motor, a curbed tube, an upper end of which is coupled to the inlet tube, and an outlet tube coupled to an end of the curved tube, and
the apparatus comprising:
a first flattener configured to uniformly disperse and flatten piles of coal dropped and input from the dust reducer to surfaces of the first upper transfer plates, which face the upper side, and transferred on the surfaces of the first upper transfers plates;
a first dust shield having left and right side plates each having a circular arc-shaped first guide hole and a circular arc-shaped second guide hole formed on upper and lower sides of the left and right side plates, having a rear plate integrally coupled to the left and right side plates, having a shock supporting step protruding upwards from an upper end of the rear plate to support bottom surfaces of the first upper transfer plates separated and dropped from the first guide rails, and having a shield compression plate, an upper portion of which is hinge-coupled to a front surface between the left and right side plates and which has first bosses protruding from opposite sides of a central portion of the shield compression plate and inserted into the first guide holes, and has second bosses protruding from opposite sides of a lower portion of the shield compression plate and inserted into the second guide holes, wherein the second bosses are elastically supported by elastic bodies formed at ends of the left and right side plates;
a third flattener configured to uniformly disperse and flatten the piles of coal dropped and input from the first coal dryer to surfaces of the second upper transfer plates of the second coal dryer, which face the upper side, and transferred on the surfaces of the second upper transfer plates of the second coal dryer; and
a second dust shield having left and right side plates each having a circular arc-shaped first guide hole and a circular arc-shaped second guide hole formed on upper and lower sides of the left and right side plates, having a rear plate integrally coupled to the left and right side plates, having a shock supporting step protruding upwards from an upper end of the rear plate to support bottom surfaces of the second upper transfer plates separated and dropped from the third guide rails, and having a shield compression plate, an upper portion of which is hinge-coupled to a front surface between the left and right side plates and which has first bosses protruding from opposite sides of a central portion of the shield compression plate and inserted into the first guide holes, and has second bosses protruding from opposite sides of a lower portion of the shield compression plate and inserted into the second guide holes, wherein the second bosses are elastically supported by elastic bodies formed at ends of the left and right side plates,
wherein the first dust shield receives the piles of coal dropped from the surfaces of the first upper transfer plates to transfer the piles of coal to surfaces of the first lower transfer plates so as to shield dust, and the second dust shield receives the piles of coal dropped from the surfaces of the second upper transfer plates to transfer the piles of coal to the second lower transfer plates so as to shield dust.

6. The apparatus of claim 5, wherein a second flattener configured to uniformly disperse and flatten the piles of coal discharged from the first dust shield to the surfaces of the first lower transfer plates and transferred on the surfaces of the first lower transfer plates is installed, and a fourth flattener configured to uniformly disperse and flatten the piles of coal discharged from the second dust shield to the surfaces of the third lower transfer plates and transferred on the surfaces of the third lower transfer plates is further installed.

7. The apparatus of claim 5, wherein each of the first dust shield and the second dust shield comprises an input port formed between the rear plate and the shield compression plate, to which the piles of coal are input, a focusing part configured to focus the input piles of coal using elasticity, and a flattening discharging part configured to uniformly discharge the focused piles of coal to surfaces of transfer plates.

8. An apparatus for reducing dust according to supply of dropping coal in a coal dryer using reheat steam, the coal dryer comprising:
a first coal dryer comprising a pair of first driving sprockets and a pair of first driven sprockets fastened to each other by first chains to be spaced apart from each other by a specific distance, a plurality of first transfer plates hinge-coupled between the first chains, a pair of first guide rails installed below a first upper chain connected between the first driving sprockets and the first driven sprockets to horizontally support first upper transfer plates, a pair of second guide rails installed below a first lower chain connected between the first driving sprockets and the first driven sprockets to horizontally support first lower transfer plates, a first steam chamber installed below the first upper chain to spray reheat steam supplied by a reheater, a second steam chamber installed below the first lower chain to spray the reheat steam supplied by the reheater, a first flue gas chamber installed above the first upper chain to collect flue gas, and a second flue gas chamber installed above the first lower chain to collect flue gas; and
a second coal dryer comprising a pair of second driving sprockets and a pair of second driven sprockets fastened to each other by second chains to be spaced apart from each other by a specific distance, a plurality of second transfer plates hinge-coupled between the second chains, a pair of third guide rails installed below a second upper chain connected between the second driving sprockets and the second driven sprockets to horizontally support second upper transfer plates, a pair of fourth guide rails installed below a second lower chain connected between the second driving sprockets and the second driven sprockets to horizontally support second lower transfer plates, a third steam chamber installed below the second upper chain to spray the reheat steam supplied by the reheater, a fourth steam chamber installed below the second lower chain to spray the reheat steam supplied by the reheater, a third flue gas chamber installed above the second upper chain to collect flue gas, and a fourth flue gas chamber installed above the lower chain to collect flue gas,
wherein coal primarily dried by the first coal dryer is input to the second coal dryer to be secondarily dried,
the coal dryer further comprising:
a fixed quantity coal supplier configured to supply a specific amount of coal to surfaces of the first transfer plates, which face the upper side; and
a dust reducer comprising an inlet tube coupled to an outlet of the fixed quantity coal supplier by a bearing, a worm wheel coupled to an outer peripheral surface of the inlet tube, a worm gear-coupled to the worm wheel and rotated by rotational force transferred from a motor, a curbed tube, an upper end of which is coupled to the inlet tube, and an outlet tube coupled to an end of the curved tube, and
the apparatus comprising:
a first flattener configured to uniformly disperse and flatten piles of coal dropped and input from the dust reducer to surfaces of the first upper transfer plates, which face the upper side, and transferred on the surfaces of the first upper transfers plates;
a first deceleration and dust shield having a vertically penetrated square column-shaped body, having a first right inclined plate formed on an upper side of an inner right surface of the body to be inclined to the left lower side at a specific angle, having a first left inclined plate formed on a left surface of the body below the first right inclined plate to be inclined to the right lower side at a specific angle, having a second right inclined plate formed on a right surface below the first left inclined plate to be inclined to the left lower side at a specific angle, having a second left inclined plate formed on the left surface of the body below the second right inclined plate to be inclined to the right lower side at a specific angle, having an outlet formed at a lower portion of the body to be inclined at a specific angle, having an inlet formed at an upper end of the body, and having a shock supporting step protruding upwards form a right upper end of the inlet to support bottom surfaces of the first upper transfer plates separated and dropped from the first guide rails;
a third flattener configured to uniformly disperse and flatten the piles of coal dropped and input from the first coal dryer to surfaces of the second upper transfer plates of the second coal dryer, which face the upper side, and transferred on the surfaces of the second upper transfer plates of the second coal dryer; and
a first deceleration and dust shield having a vertically penetrated square column-shaped body, having a first right inclined plate formed on an upper side of an inner right surface of the body to be inclined to the left lower side at a specific angle, having a first left inclined plate formed on a left surface of the body below the first right inclined plate to be inclined to the right lower side at a specific angle, having a second right inclined plate formed on a right surface below the first left inclined plate to be inclined to the left lower side at a specific angle, having a second left inclined plate formed on the left surface of the body below the second right inclined plate to be inclined to the right lower side at a specific angle, having an outlet formed at a lower portion of the body to be inclined at a specific angle, having an inlet formed at an upper end of the body, and having a shock supporting step protruding upwards form a right upper end of the inlet to support bottom surfaces of the second upper transfer plates separated and dropped from the third guide rails,
wherein the first deceleration and dust shield receives the piles of coal dropped from surfaces of the first upper transfer plates to transfer the piles of coal to surfaces of the first lower transfer plates while the piles of coal are decelerated, so as to shield dust, and the second deceleration and dust shield receives the piles of coal dropped from the surfaces of the second upper transfer plates to transfer the piles of coal to the surfaces of the second lower transfer plates while the piles of coal are decelerated, so as to shield dust.

9. The apparatus of claim 8, wherein a second flattener configured to uniformly disperse and flatten the piles of coal discharged from the first deceleration and dust shield to the surfaces of the first lower transfer plates and transferred on the surfaces of the first lower transfer plates is installed, and a fourth flattener configured to uniformly disperse and flatten the piles of coal discharged from the second deceleration and dust shield to the surfaces of the third lower transfer plates and transferred on the surfaces of the third lower transfer plates is further installed.

10. The apparatus of claim 6, wherein each of the first flattener and the third flattener comprises a column-shaped body, a dispersion boss protruding from a central portion of a front surface of the body, and a pair of fixing members configured to fixedly support opposite ends of the body.

11. The apparatus of claim 1, wherein a dropping coal decelerator in which left inclined plates and right inclined plates are alternately installed at a specific angle and a specific internal is formed between an outlet of the first coal dryer and an inlet of the second coal dryer.

12. The apparatus of claim 6, wherein each of the second flattener and the fourth flattener comprises a column-shaped body, a dispersion boss protruding from a central portion of a front surface of the body, and a pair of fixing members configured to fixedly support opposite ends of the body.

13. The apparatus of claim 1, wherein first transfer rollers are hinge-coupled between centers of opposite sides of each of the first transfer plates and the first chains, respectively, first auxiliary rollers are hinge-coupled to side surfaces of the first transfer plate on left and right sides of the first transfer rollers, respectively, second transfer rollers are hinge-coupled between centers of opposite sides of each of the second transfer plates and the second chains, respectively, second auxiliary rollers are hinge-coupled to side surfaces of the second transfer plate on left and right sides of the second transfer rollers, respectively, first guide bars configured to unidirectionally rotate and upwards support first lower transfer plates separated from the second guide rails are installed from an upper side via a lateral side to a lower side of the first driving sprockets, second guide bars configured to unidirectionally rotate and downwards support first upper transfer plates separated from the first guide rails are installed from a lower side via a lateral side to an upper side of the first driven sprockets, third guide bars configured to unidirectionally rotate and upwards support second lower transfer plates separated from the fourth guide rails are installed from an upper side via a lateral side to a lower side of the second driving sprockets, and fourth guide bars configured to unidirectionally rotate and downwards support second upper transfer plates separated from the third guide rails are installed from a lower side via a lateral side to an upper side of the second driven sprockets.

14. The apparatus of claim 13, wherein a first trigger to a fourth trigger are coupled to distal ends of the first guide bars to the fourth guide bars, respectively, the first trigger is installed at a location that is in contact with sides of bottom surfaces of the first upper transfer plates, the second trigger is installed at a location that is in contact with sides of flat surfaces of the first lower transfer plates, the third trigger is installed at a location that is in contact with sides of bottom surfaces of the second upper transfer plates, and the fourth trigger is installed at a location that is in contact with sides of flat surfaces of the second lower transfer plates.

15. The apparatus of claim 13, wherein the first trigger to the fourth trigger are axially rotating rollers, respectively.

16. The apparatus of claim 13, wherein grooves are formed on surfaces of the first guide rails and the second guide rails to guide rotation of the first transfer rollers and the first auxiliary rollers, and grooves are formed on surfaces of the third guide rails and the fourth guide rails to guide rotation of the second transfer rollers and the second auxiliary rollers.

17. The apparatus of claim 13, wherein an interval between a left end of the second guide rails and a lower end of the first guide bars and an interval between a right end of the first guide rails and an upper end of the second guide bars are smaller than a width of the first transfer plate, and an interval between a left end of the fourth guide rails and a lower end of the third guide bars and an interval between a left of the third guide rails and an upper end of the fourth guide bars are smaller than a width of the second transfer plate.
